(19) United States
(12) Patent Application Publication
(10) Pub. No.: US 2026/0023396 A1
(43) Pub. Date: Jan. 22, 2026

(54) A METHOD AND SYSTEM FOR CONTROLLING THE FLIGHT OF A PLURALITY OF QUADCOPTERS

(71) Applicant: KING FAHD UNIVERSITY OF PETROLEUM AND MINERALS, Dhahran (SA)

(72) Inventors: Muhammad MAARUF, Dhahran (SA); Sami EL FERIK, Dhahran (SA)

(73) Assignee: KING FAHD UNIVERSITY OF PETROLEUM AND MINERALS, Dhahran (SA)

(21) Appl. No.: 19/093,137

(22) Filed: Mar. 27, 2025

Related U.S. Application Data
(60) Provisional application No. 63/673,392, filed on Jul. 19, 2024.

(51) Int. Cl. G05D 1/698; G05D 109/25; G08G 5/57; H04W 4/46

(52) U.S. Cl. CPC G05D 1/6985; G08G 5/57; H04W 4/46; G05D 2109/25

(57) ABSTRACT

A method and system for controlling the flight of a plurality of quadcopters includes communicating a flight instruction from a user to a leader quadcopter. The method includes calculating a leader formation maneuver and a follower formation maneuver with a leader-follower formation controller configured to use affine transformations and stress matrices to convert a flight instruction into a leader formation maneuver and a follower formation maneuver. The method may include communicating the follower formation maneuver from the leader quadcopter to a follower quadcopter. The method may include executing the leader formation maneuver on the leader quadcopter. The method may include executing the follower formation maneuver on the follower quadcopter.

### CROSS-REFERENCE TO RELATED APPLICATIONS

This application is related to provisional application 63/673,392, filed Jul. 19, 2024, incorporated herein by reference.

### STATEMENT OF PRIOR DISCLOSURE BY AN INVENTOR

Aspects of this technology are described in Muhammad Maaruf and Sami El-Ferik, “Reinforcement Learning-Based Control Strategy for Multi-Agent Systems Subjected to Actuator Cyberattacks During Affine Formation Maneuvers”, Published in IEEE Access, vol. 11, pp. 77656-77668, which is also incorporated herein by reference in its entirety.

### BACKGROUND

### Technical Field

The present disclosure is directed to a method and a system for controlling flight of a plurality of quadcopters.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In recent years, there has been a push to develop improved systems for the control of a group of quadrotors. Collective formation flights have important advantages when compared to a single quadrotor in both civil and military applications, such as disaster relief, aerial photography, disaster management, rescue, military reconnaissance, and so on. A group of quadrotors can have any prescribed formation shape through the design of appropriate formation control protocols. Moreover, formation control laws can be augmented to set the whole formation of quadrotors to preform maneuvers. Conventional control schemes guarantee the acquisition of the desired formation shape and stability of the quadrotors, but the safety of formation maneuvers within a constrained working space is overlooked. Therefore, the motion (vertical and horizontal displacements) of the quadrotors should be limited according to a defined safety range to improve reliability, health, and life span of the quadrotors. When the safety boundary is exceeded, the formation control performance of the system may be degraded, which can lead to operation failure. Despite various publications on reinforcement learning-based formation control of multiple quadrotors, to the best of our knowledge, reinforcement learning-based distributed sliding mode formation control of multiple quadrotors, with safety constraints, designed to resist multiple types of cyber-attacks, has not been studied. The process of acquiring target formation shape can be broadly classified as a bearing, distance, or relative-position approach. Each of the approaches has its own merits and shortcomings. For example, through the bearing approach, the quadrotors can accomplish scaling and translation formation maneuvers. On the other hand, the distance approach can realize formation translation and rotation maneuvers. Meanwhile, the formation shape described by the relative-position strategy can achieve a translation maneuver. In order to accomplish formation scaling, translation, and rotation simultaneously, an affine formation maneuver control strategy based on stress matrix and affine transformation theory has been developed for multi-agent systems described by time-delayed linear dynamic equations, second-order integrator dynamic equations, triple-integrator dynamic equations, high-order linear dynamic equations, and second-order nonlinear systems. Designing formation maneuver control for multiple quadrotors using stress matrices and affine transformation theory will give more freedom of maneuverability to quadrotors. Therefore, affine formation maneuver control of networked quadrotors needs urgent attention.

The aforementioned conventional methods and systems for quadrotor control suffer from one or more drawbacks hindering their adoption. Accordingly, it is one object of the present disclosure to provide an efficient method and system for controlling the flight of quadcopters.

### SUMMARY

In an exemplary embodiment, a method for controlling the flight of a plurality of quadcopters is described. The method includes communicating a flight instruction from a user to a leader quadcopter. The method also includes calculating a leader formation maneuver and a follower formation maneuver with a leader-follower formation controller configured to use affine transformations and stress matrices to convert a flight instruction into a leader formation maneuver and a follower formation maneuver. The method also includes communicating the follower formation maneuver from the leader quadcopter to a follower quadcopter. The method also includes executing the leader formation maneuver on the leader quadcopter. The method also includes executing the follower formation maneuver on the follower quadcopter.

In another exemplary embodiment, a method for controlling the flight of a plurality of quadcopters is described. The method includes communicating a flight instruction from a user to a leader quadcopter. The method also includes calculating a leader formation maneuver and a follower formation maneuver with a leader-follower formation controller configured to use a distributed sliding mode control and an actor-critic learning mechanism to convert a flight instruction into a leader formation maneuver and a follower formation maneuver. The method also includes communicating the follower formation maneuver from the leader quadcopter to a follower quadcopter. The method also includes executing the leader formation maneuver on the leader quadcopter. The method also includes executing the follower formation maneuver on the follower quadcopter.

In another exemplary embodiment, a system for controlling a plurality of quadcopters is described. The system includes a user input device configured to receive a flight instruction from a user and deliver the flight instruction to a leader quadcopter. The system also includes a leader quadcopter configured to receive a flight instruction from a user input device, calculate a leader formation maneuver, calculate a follower formation maneuver with a leader-follower formation controller configured to use affine transformations and stress matrices to calculate the follower formation maneuver and communicate the follower formation maneuver to a follower quadcopter and execute the leader formation maneuver. The system also includes a follower quadcopter configured to receive the follower formation maneuver and execute the follower formation maneuver.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A depicts a block diagram of a system for controlling a plurality of quadcopters, according to certain embodiments.

FIG. 1B depicts several formation shape maneuvers of a plurality of quadcopters, according to certain embodiments.

FIG. 2 depicts a nominal formation of the quadrotors, according to certain embodiments.

FIG. 3A depicts a graph of a leader-follower time-varying position trajectories in x-axis, according to certain embodiments.

FIG. 3B depicts a graph of a leader-follower time-varying position trajectories in y-axis, according to certain embodiments.

FIG. 4A depicts a graph of tracking errors of followers in the x-axis, according to certain embodiments.

FIG. 4B depicts a graph of tracking errors of followers in the y-axis, according to certain embodiments.

FIG. 5A depicts a graph of actor-critic learning control protocols of the followers in the x-axis, according to certain embodiments.

FIG. 5B depicts a graph of actor-critic learning control protocols of the followers in the y-axis, according to certain embodiments.

FIG. 6A-FIG. 6H depicts a graph of Norm-2 of actor weights, according to certain embodiments.

FIG. 7A-FIG. 7H depicts a graph of Norm-2 of critic weights, according to certain embodiments.

FIG. 8 depicts a graph of leader-follower affine formation maneuvers, according to certain embodiments.

FIG. 9 depicts a flowchart of a method for controlling the flight of a plurality of quadcopters, according to certain embodiments.

FIG. 10 depicts a flowchart of a method for controlling the flight of a plurality of quadcopters, according to certain other embodiments.

FIG. 11 depicts a block diagram of a computer and/or networked device configured to communicate with at least one quadcopter of the plurality of quadcopters according to certain embodiments.

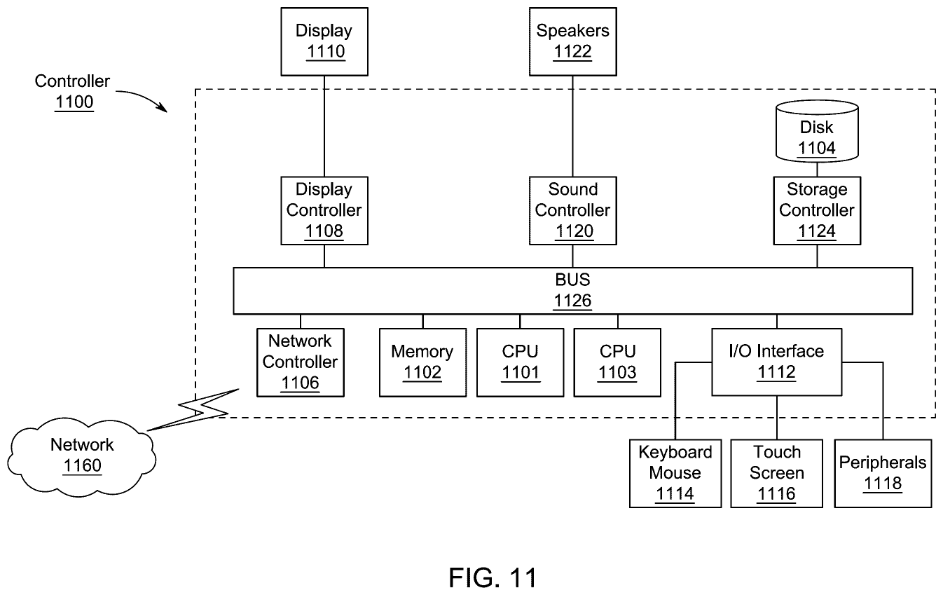

FIG. 12 depicts a block diagram of networked device configured to communicate with at least one quadcopter of the plurality of quadcopters according to certain other embodiments.

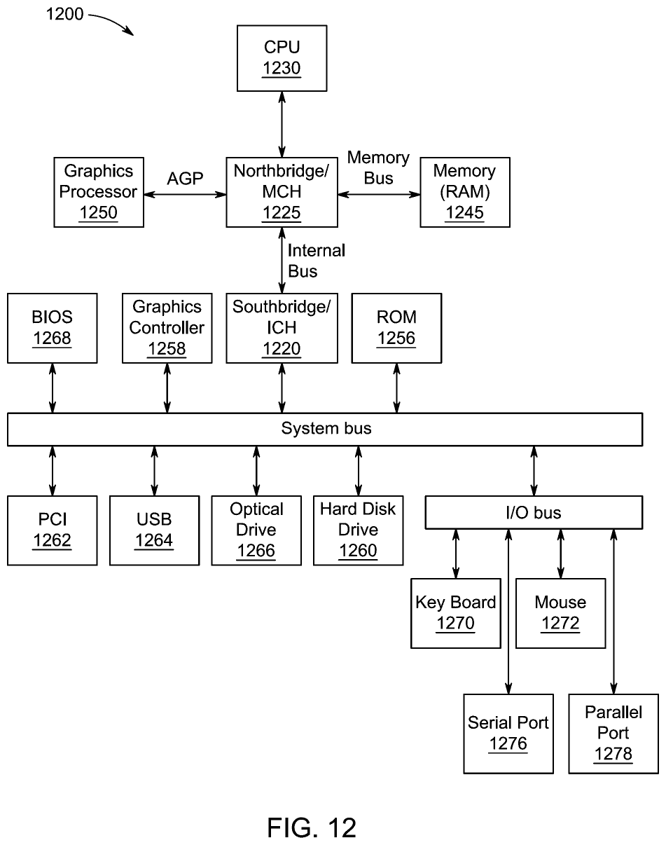

FIG. 13 depicts a block diagram of a central processing unit configured to process information related to the controlling of at least one quadcopter of the plurality of quadcopters according to certain embodiments.

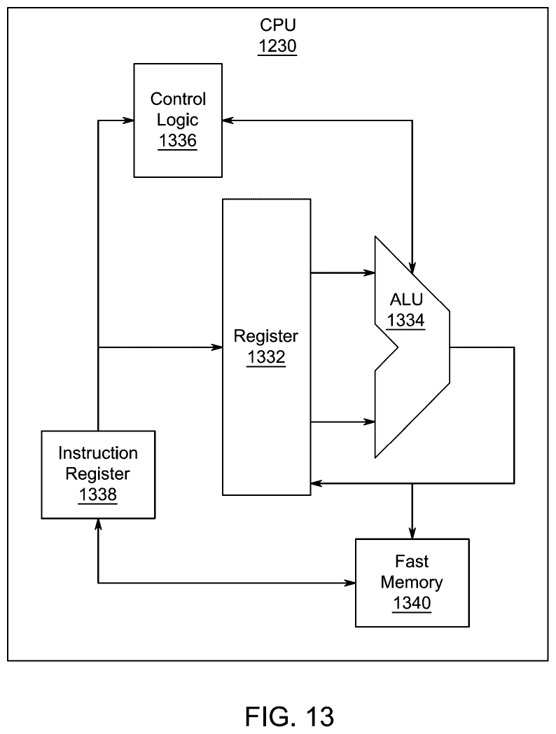

FIG. 14 depicts a network diagram of a communication network configured to relay information to and from at least one networked device configured to communicate with at least one quadcopter of the plurality of quadcopters according to certain embodiments.

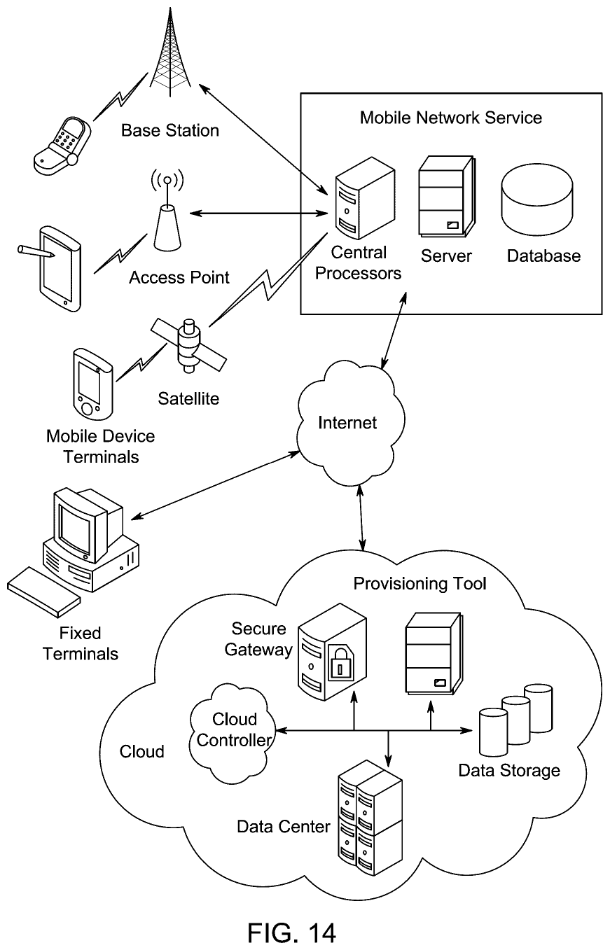

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about” and similar terms generally refer to ranges that include the identified value within a margin of 20%, 10%, or preferably 5%, and any values therebetween.

The term “affine formation maneuver” refers to a maneuver of a plurality of objects in formation which retain a spatial relationship consistent with an affine transformations. The term “affine transformation” may refer to the class of linear mapping methods which preserves points, straight lines, and planes, but do not necessarily preserve Euclidian distances or angles. Therefore, the geometry of a formation at a first point in time will have the same points, straight lines, and planes of the geometry of the formation after an affine formation maneuver has been performed.

The terms “leader” and “follower” may describe the independently controlled components of a leader-follower control scheme respectively. In a leader-follower control scheme, at least one member of the control scheme is chosen as a leader and the leader(s) may dictate or decide the whole formation group's moving trajectory, typically by communicating commands to the non-deciding “follower” members. In one embodiment of a leader-follower control scheme a user may send user commands to leader vehicles, thereby externally controlling the leaders. The leaders may then send information about the user commands and/or send follower commands to the follower vehicles which may act on those instructions, thereby internally controlling the followers. In another embodiment, the user commands may be additionally or alternatively be sent to the followers by a user or a separate computer and/or networked device.

According to an embodiment, an actor-critic learning scheme for safe leader-follower affine formation maneuver control of networked quadrotor unmanned aerial vehicles (UAVs) is described in the face of external disturbances, sensor deception attacks, and injection attacks on the actuators. Typically, the follower quadrotors (followers) aim to track the formation maneuvers such as scaling, shearing, translation, and rotation decided by the leader quadrotors (leaders). Motivated by increasing safety and performance requirements during formation maneuvering, the dynamic states of the quadrotor UAVs are constrained within the prescribed safety region. The term “dynamic states” may refer to the full range of actual positions/formations that the UAVs may be arranged in during operation.

To guarantee that the safety constraints are not violated, a barrier Lyapunov function may be used. A distributed sliding mode control with actor-critic learning is also formulated and implemented to facilitate accurate leader-follower affine formation maneuvers and reject malicious cyber-attack signals. A sliding mode control may refer to any nonlinear control method that alters the dynamics of a nonlinear system, such as a flight path, by applying a discontinuous control signal which forces the system to “slide” along a cross-section of the system's normal behavior thereby regulating the system. The term “actor-critic learning” may refer to a machine reinforcement learning system wherein software is trained on the outcomes of actions its decisions have informed such that it will make more effective decisions in the future.

Additionally, input gains that arise due to the attacks might corrupt the control direction and so in the present disclosure, a Nussbaum gain function is coupled to the controller to address input gain corruption. The actor system may be responsible for estimating uncertain dynamics together with the malicious attack signals, while the critic network evaluates the control performance through an estimated long-term performance index. In the method and system of the present disclosure, the overall stability of the closed-loop system can be uniformly bounded using a Lyapunov stability function.

In view of the foregoing discussion, the present disclosure provides a solution for leader-follower affine formation maneuver control of networked quadrotor unmanned aerial vehicles (UAVs) subjected to external disturbances, sensor deception attacks, and actuator injection attacks. By considering the safety and physical limitations of the quadrotor UAVs, their dynamic states are constrained to operate within a safe workspace. To prevent violation of the safety constraints, in the method and system of the present disclosure, a barrier Lyapunov function is involved to improve the safety of the system. The safety of the system may refer to the operational conditions under which the formation may maneuver without risking a loss of control of an individual UAV, collisions between UAVs, or some other undesirable flight path for the formation. Then, the actor-critic learning-based distributed sliding mode control technique is designed to aid the leader-follower formation maneuvers of the quadrotor UAVs within the prescribed workspace while mitigating cyber-attacks. The present disclosure provides a method and system that utilizes the properties of affine transformation and stress matrices, and various collective affine formation maneuvers of the networked quadrotor UAVs such as scaling, translation, rotation, shearing, and collinearity. Moreover, the quadrotors in this technology have improved freedom of maneuverability. The present disclosure addresses a safety-guaranteed leader-follower affine formation maneuver control problem associated with multiple quadrotor UAVs under sensor deception attacks and actuator injection attacks. Compared with the conventional systems, where the problem of input gains induced by attack signals was not considered, the present disclosure addresses this problem by integrating the Nussbaum function into the controller of the present disclosure. As such, the controller of the present disclosure does not require any prior information about the signs of the input gains induced by the attack signals to counteract them. In conventional systems the learning-based controllers are in the form of linear quadratic regulators, in contrast, the present disclosure utilizes a distributed sliding mode control approach integrated with a learning mechanism.

According to an embodiment, the quadrotor of the present disclosure is a system having six degrees of freedom with four control inputs. Assuming that the quadrotor framework is rigid and symmetric, and the center of gravity coincides with the body-frame origin, the dynamic equations of the displacement and rotation of the quadrotor are as given by equations (1) to (6):

$${{ϕ}^{`}}_{i} = \frac{1}{{I}_{x}} [ ( {I}_{y} - {I}_{z} ) {{ψ}^{`}}_{i} {{θ}^{`}}_{i} - {a}_{1} {{ϕ}^{`}}_{i}^{2} - {I}_{p} Ω {{θ}^{`}}_{i} + {lu}_{2 i} ] + {Δ}_{ϕ i} \qquad ( 1 )$$

$${{θ}^{`}}_{i} = \frac{1}{{I}_{y}} [ ( {I}_{z} - {I}_{x} ) {{ψ}^{`}}_{i} {ϕ}^{`} - {a}_{2} {{θ}^{`}}_{i}^{2} + {I}_{p} Ω {{ϕ}^{`}}_{i} + {lu}_{3 i} ] + {Δ}_{θ i} \qquad ( 2 )$$

$${{ψ}^{`}}_{i} = \frac{1}{{I}_{z}} [ ( {I}_{x} - {I}_{y} ) {{ϕ}^{`}}_{i} {{θ}^{`}}_{i} - {a}_{3} {{ψ}^{`}}_{i}^{2} + {lu}_{4 i} ] + {Δ}_{ψ i} \qquad ( 3 )$$

$${{x}^{`}}_{i} = - \frac{{a}_{4} {{x}^{`}}_{i}}{m} + ( cos {ϕ}_{i} sin {θ}_{i} cos {ψ}_{i} + sin {ϕ}_{i} sin {ψ}_{i} ) \frac{{u}_{1 i}}{m} + {Δ}_{xi} \qquad ( 4 )$$

$${{y}^{`}}_{i} = - \frac{{a}_{5} {{y}^{`}}_{i}}{m} + ( cos {ϕ}_{i} sin {θ}_{i} sin {ψ}_{i} - sin {ϕ}_{i} cos {ψ}_{i} ) \frac{{u}_{1 i}}{m} + {Δ}_{yi} \qquad ( 5 )$$

$${{z}^{`}}_{i} = - \frac{{a}_{6} {{z}^{`}}_{i}}{m} + ( cos {ϕ}_{i} cos {θ}_{i} ) \frac{{u}_{1 i}}{m} - \frac{g}{m} + {Δ}_{zi} \qquad ( 6 )$$

wherein x, y, and z denote the position of the quadrotors in the earth frame, θ, ψ, and ϕ represent the roll, yaw, and pitch angles, respectively, Δ_{ϕi}, Δ_{θi}, Δ_{ψi}, Δₓᵢ, Δ_{yi}, and Δ_{ϕ} stand for the unknown time-varying external disturbances, l is the length from the center of each actuator to the center of mass, Iₚ is the propeller inertia, Iₓ, I_{y}, I_{z} are the moment of inertia along the x, y, and z axes, respectively, g represents gravitational acceleration, a₁, a₂, a₃, a₄, a₅, and a₆ stand for the drag coefficients, u₁ᵢ, u₂ᵢ, u₃ᵢ, and u₄ᵢ denote the control inputs.

The three-degree-of-freedom translational equations of the N quadrotors are given by equations (7) to (9):

$${{x}^{`}}_{i} = - \frac{{a}_{4} {{x}^{`}}_{i}}{m} + {u}_{xi} + {Δ}_{xi} \qquad ( 7 )$$

$${{y}^{`}}_{i} = - \frac{{a}_{5} {{y}^{`}}_{i}}{m} + {u}_{yi} + {Δ}_{yi} \qquad ( 8 )$$

$${{z}^{`}}_{i} = - \frac{{a}_{6} {{z}^{`}}_{i}}{m} + {u}_{zi} + {Δ}_{zi} \\ where \\ {u}_{xi} = ( cos {ϕ}_{i} sin {θ}_{i} cos {ψ}_{i} + sin {ϕ}_{i} sin {ψ}_{i} ) \frac{{u}_{1 i}}{m} \\ {u}_{yi} = ( cos {ϕ}_{i} sin {θ}_{i} sin {ψ}_{i} - sin {ϕ}_{i} cos {ψ}_{i} ) \frac{{u}_{1 i}}{m} \\ {u}_{zi} = ( cos {ϕ}_{i} cos {θ}_{i} ) \frac{{u}_{1 i}}{m} - \frac{g}{m} \qquad ( 9 )$$

Assuming that the quadrotors are flying at the same altitude, the translational equations of the quadrotors in two-dimensional space can be written as:

$${{q}^{`}}_{i} = {{Υ}^{↼}}_{i} ( {q}_{i} , {{q}^{`}}_{i} ) + {u}_{i} + {Δ}_{i} where \\ {q}_{i} = {[ \begin{matrix}{x}_{i} & {y}_{i}\end{matrix} ]}^{T} ∈ {ℝ}^{2} , \\ {u}_{i} = {[ \begin{matrix}{u}_{xi} & {u}_{yi}\end{matrix} ]}^{T} ∈ {ℝ}^{2} , \\ {{Υ}^{↼}}_{i} ( {q}_{i} , {{q}^{`}}_{i} ) = {[ - \frac{{a}_{4} {{x}^{`}}_{i}}{m} - \frac{{a}_{5} {{y}^{`}}_{i}}{m} ]}^{T} ∈ {ℝ}^{2} , \\ {Δ}_{i} = {[ \begin{matrix}{Δ}_{xi} & {Δ}_{yi}\end{matrix} ]}^{T} ∈ {ℝ}^{2} . \qquad ( 10 )$$

The dynamic states of the quadrotors in equation (10) are constrained in the following compact sets:

$$\vert {q}_{i} \vert = [ \begin{matrix}\vert {x}_{i} \vert \\ \vert {y}_{i} \vert\end{matrix} ] < [ \begin{matrix}{k}_{ci} \\ {k}_{ci}\end{matrix} ] \qquad ( 11 )$$

where k_{ci}>0 is a constant. The compact set (11) specifies the region of safety operation of the quadrotors.

Assumption 1: Let qᵢ* be the target position of each quadrotor. It is assuming that

$${q}_{i}^{*}$$

is bounded as:

$$\vert {q}_{i}^{*} \vert = [ \begin{matrix}\vert {x}_{i} \vert \\ \vert {y}_{i} \vert\end{matrix} ] < [ \begin{matrix}{\prod }_{i} \\ {\prod }_{i}\end{matrix} ] < [ \begin{matrix}{k}_{ci} \\ {k}_{ci}\end{matrix} ] \qquad ( 12 )$$

and its 1st and 2nd derivatives are bounded as follows:

$$\vert {{q}^{`}}_{i} \vert = [ \begin{matrix}\vert {{x}^{`}}_{i} \vert \\ \vert {{y}^{`}}_{i} \vert\end{matrix} ] < [ \begin{matrix}{\prod }_{i}^{′} \\ {\prod }_{i}^{′}\end{matrix} ] < [ \begin{matrix}{k}_{ci} \\ {k}_{ci}\end{matrix} ] \qquad ( 13 )$$

$$\vert {{q}^{`}}_{i} \vert = [ \begin{matrix}\vert {{x}^{`}}_{i} \vert \\ \vert {{y}^{`}}_{i} \vert\end{matrix} ] < [ \begin{matrix}{\prod }_{i}^{″} \\ {\prod }_{i}^{″}\end{matrix} ] < [ \begin{matrix}{k}_{ci} \\ {k}_{ci}\end{matrix} ] where {\prod }_{i} > 0 , {\prod }_{i}^{′} > 0 and {\prod }_{i}^{′} > 0 \qquad ( 14 )$$

are constants,

The two-dimension translational equations of the quadrotors in the face of cyber-attacks are given as:

$$\{ \begin{matrix}{{q}^{‵}}_{i} = {{Υ}^{↼}}_{i} ( {q}_{i} , {{q}^{‵}}_{i} ) + {{u}^{‵}}_{i} + {Δ}_{i} \\ {{q}^{‵}}_{i} = {q}_{i} + {δ}_{i} ( t , {q}_{i} ) \\ {{u}^{‵}}_{i} = {\underline{h}}_{i} {u}_{i} + {{h}^{↼}}_{i} ( t , {q}_{i} , {{q}^{‵}}_{i} )\end{matrix} \qquad ( 15 )$$

wherein \grave{q}ᵢ∈ [symbol] ² is the vector of the compromised states, ùᵢ∈ [symbol] ² is the vector of the compromised control inputs, δᵢ(t, qᵢ)∈ [symbol] ² is the vector of the deception attack signals, [symbol] ᵢ=[ [symbol] ]^{T}∈ [symbol] ² is the vector of time-varying injected attack signals, and hᵢ=dia g{hₓᵢh_{yi}}∈ [symbol] ^{2×2}

The deception attack signals can be described by state-dependent function as δᵢ(t, qᵢ)=κᵢ(t)qᵢ since they are mimicking the state variables, where κᵢ(t)∈ [symbol] ^{2×2} is a time-varying weight. Thus, the quadrotor states corrupted by the deception attacks are given as:

$${{q}^{‵}}_{i} = {q}_{i} + {κ}_{i} ( t ) {q}_{i} = {φ}_{i} ( t ) {q}_{i} \qquad ( 16 )$$

where φᵢ(t)=(1+κᵢ(t))

As a result of the attack, the actual state variables qᵢ are no longer available. Therefore, the contaminated state variables qᵢ will be utilized for control design.

Deriving from (16):

$${\dot{\breve{q}}}_{l} = {\dot{φ}}_{l} {q}_{i} + {φ}_{i} {\dot{q}}_{l} \qquad ( 17 )$$

$${\ddot{\breve{q}}}_{l} = {\ddot{φ}}_{l} {q}_{i} + 2 {\dot{φ}}_{l} {\dot{q}}_{l} + {φ}_{i} {\ddot{q}}_{l} \qquad ( 18 )$$

Noting that

$${q}_{i} = \frac{{{q}^{‵}}_{i}}{{φ}_{i}} and {{q}^{‵}}_{i} = \frac{1}{{φ}_{i}} [ {\dot{\breve{q}}}_{l} - {{φ}^{‵}}_{i} \frac{{{q}^{‵}}_{i}}{{φ}_{i}} ]$$

and 15, (18) becomes:

$${{q}^{‵}}_{i} = {{φ}^{‵}}_{i} \frac{{{q}^{‵}}_{i}}{{φ}_{i}} + 2 \frac{{{φ}^{‵}}_{i}}{{φ}_{i}} [ {{{q}^{‵}}^{‵}}_{i} - {{φ}^{‵}}_{i} \frac{{{q}^{‵}}_{i}}{{φ}_{i}} ] + {φ}_{i} {{Υ}^{↼}}_{i} + {φ}_{i} {Δ}_{i} + {φ}_{i} {\underline{h}}_{i} {u}_{i} + {φ}_{i} {{h}^{↼}}_{i} \qquad ( 19 )$$

The quadrotor systems under the cyber-attacks could be expressed as:

$${{q}^{‵}}_{i} = {Υ}_{i} + {g}_{i} {u}_{i} where {Υ}_{i} = {{φ}^{‵}}_{i} \frac{{{q}^{‵}}_{i}}{{φ}_{i}} + 2 \frac{{{φ}^{‵}}_{i}}{{φ}_{i}} [ {{\vec{q}}^{‵}}_{i} - {{φ}^{‵}}_{i} \frac{{{q}^{‵}}_{i}}{{φ}_{i}} ] + {φ}_{i} {{Υ}^{↼}}_{i} + {φ}_{i} {Δ}_{i} + {φ}_{i} {{h}^{↼}}_{i} , \\ and {g}_{i} = {φ}_{i} {\underline{h}}_{i} . \qquad ( 20 )$$

The N quadrotors in (20) can be partitioned into two groups: the Nₗ leaders and N_{f}=(N−Nₗ) followers.

Let \grave{q}ₗ and \grave{q}_{f} be the vectors of the Nₗ leaders and N_{f} followers, respectively. Then:

$${{q}^{‵}}_{l} = {[ \begin{matrix}{{q}^{‵}}_{1}^{T} & {{q}^{‵}}_{2}^{T} … {{q}^{‵}}_{{N}_{l}}^{T}\end{matrix} ]}^{T} \qquad ( 21 )$$

$${{q}^{‵}}_{f} = {[ \begin{matrix}{{q}^{‵}}_{{N}_{l} + 1}^{T} & {{q}^{‵}}_{{N}_{l} + 2}^{T} … {{q}^{‵}}_{{N}_{l} + {N}_{f}}^{T}\end{matrix} ]}^{T} \qquad ( 22 )$$

The configuration of the N quadrotors which consists of their positions in two-dimensional space under cyberattacks is thus:

$${q}^{‵} = {[ \begin{matrix}{{q}^{‵}}_{l}^{T} & {{q}^{‵}}_{f}^{T}\end{matrix} ]}^{T} = {[ \begin{matrix}{{q}^{‵}}_{1}^{T} & {{q}^{‵}}_{2}^{T} & … & {{q}^{‵}}_{N}^{T}\end{matrix} ]}^{T} ∈ {ℝ}^{2 N} \qquad ( 23 )$$

It is advantageous to provide a control law that can maintain healthy quadrotors states within the safety constraints (11) even in the presence of cyberattacks.

Assumption 2: Considering that the Nₗ leader quadrotors are already controlled to acquire the desired formation maneuvers. In this sense, the control procedure for the leader quadrotors will not be considered.

Definition 1. Given a continuous function H( [symbol] ): [symbol] → [symbol] that satisfies:

$$\{ \begin{matrix}{}_{t \to ∞} sup \frac{1}{t} {\int }_{0}^{t} N ( ς ) d ς = + ∞ \\ {}_{t \to ∞} inf \frac{1}{t} {\int }_{0}^{t} N ( ς ) d ς = - ∞\end{matrix} \qquad ( 24 )$$

then H( [symbol] ): [symbol] → [symbol] is a Nussbaum function. Many functions satisfy the condition in (24), for instance, [symbol] ² cos ( [symbol] ), e [symbol] ^{₂} cos (1/2 [symbol] ) and [symbol] ² sin( [symbol] ).

Lemma 1. Defining the smooth functions L(t) and s(t) over the range [0, t_{f}) with L(t)≥0, H(s) as a smooth Nussbaum function, the following inequality holds:

$$L ( t ) \leq {r}_{1} + {e}^{- {r}_{2} t} {\int }_{0}^{t} [ g ( . ) H ( ς ) + 1 ] {ζ}^{‵} {e}^{{r}_{2} t} dt \qquad ( 25 )$$

where r₁>0, r₂>0 are constants, g(⋅)isatime—varying function, then, L(t), [symbol] (t), and

$${\int }_{0}^{t} g ( ) N . ( ς ) {ζ}^{‵} dt$$

are bounded over [0, t_{f}].

According to an embodiment, radial basis function neural networks are commonly employed to approximate any smooth and continuous unknown term as:

$$Υ = {W}^{T} Θ ( χ ) + ε ( χ ) \qquad ( 26 )$$

where χ is the input vector, W=[w₁ w₂ . . . wₖ]^{T}∈ [symbol] ^{k} is the weight vector, k is the number of nodes in the hidden layer, ε(χ) is the approximation error and ∥ε(x)∥≤ [symbol] with [symbol] >0, Θ(χ)=[Θ₁(χ)Θ₂(χ) . . . Θₖ(χ)]^{T} represent the basis function vector with entries Θᵢ(χ) given by

$${Θ}_{i} ( χ ) = exp ( - \frac{{‖ ( χ - {{μ}^{↼}}_{i} ) ‖}^{2}}{{\underline{μ}}_{i}^{2}} ) , i = 1 , 2 , … , k \qquad ( 27 )$$

where [symbol] and μᵢ denote the center and width of the Gaussian function, respectively.

According to an embodiment, a barrier function is widely employed to guarantee the safety of dynamic systems. The barrier function tends to infinity when it reaches the barriers of the specified safety constraints, but never violates the constraints. This property is utilized to design control laws that keep dynamic systems within the safety barriers.

Lemma 2. A Lyapunov candidate function L(z) complying L(z)→∞ as |z|→c, is deployed to ensure that the state-variables boundaries are not transgressed. The Lyapunov candidate function is as follows:

$$L ( z ) = \frac{1}{2} log \frac{{c}^{2}}{{c}^{2} - {z}^{2}} \qquad ( 28 )$$

where c is the constraint on z. Thus, L is positive definite and continuous within the set |z|≤c. The control policy is developed to meet \grave{L}≤0.

Lemma 3. For any constant c>0 and z∈ [symbol] meeting |z|≤c, one gets

$$log \frac{{c}^{2}}{{c}^{2} - {z}^{2}} < \frac{{z}^{2}}{{c}^{2} - {z}^{2}} \qquad ( 29 )$$

See Y.-J. Liu, J. Li, S. Tong, C. L. P. Chen, Neural network control based adaptive learning design for nonlinear systems with full state constraints, IEEE Transactions on Neural Networks and Learning Systems 27 (2016) 1562-1571. doi 10.1109, incorporated herein by reference in its entirety.

The exchange of information among the quadrotors is modeled by an undirected graph [symbol] =( [symbol] , ε, [symbol] ) consisting of N vertices. Define [symbol] ={ν₁, . . . , ν_{N}} and ε⊆ [symbol] × [symbol] as the sets of vertices and edges, respectively. Then, the set of neighbors of the vertex i is defined by [symbol] =j∈ [symbol] :(i, j)∈ε.

The formation of the quadrotors ( [symbol] , \grave{q}) is defined as the graph of the quadrotors [symbol] =( [symbol] , ε, [symbol] ) with their corresponding configuration \grave{q}.

The scalar weight allotted to each edge of the formation ( [symbol] , q) is termed as the stress of the edge and it can be positive or negative. The set of the scalar weights is defined by {sᵢⱼ}_{(i,j)∈ε} with sᵢⱼ=sⱼᵢ∈ [symbol] . The stress matrix S∈ [symbol] ^{N×N} is described as:

$${[ S ]}_{ij} = \{ \begin{matrix}0 , & i \neq j , ( i , j ) ∉ {𝒩}_{i} \\ - {s}_{ij} , & i \neq j , ( i , j ) ∈ {𝒩}_{i} \\ {\sum }_{k ∈ {𝒩}_{i}} {s}_{ik} , & i \neq j\end{matrix} . \qquad ( 30 )$$

When the stress satisfies [symbol] sᵢⱼ(\grave{q}ⱼ−\grave{q}ᵢ)=0 or (S⊗I₂)\grave{q}=0 in compact form, it is referred to as equilibrium stress.

Thus, (30) can be rewritten as:

$${S}^{↼} = S ⊗ {I}_{2} = [ \begin{matrix}{S}_{ll} & {S}_{lf} \\ {S}_{fl} & {S}_{ff}\end{matrix} ] ⊗ {I}_{2} = [ \begin{matrix}{{S}^{↼}}_{ll} & {{S}^{↼}}_{lf} \\ {{S}^{↼}}_{fl} & {{S}^{↼}}_{ff}\end{matrix} ] . \qquad ( 31 )$$

where Sₗₗ∈ [symbol] ^{2N}^{ₗ}^{×2N}^{ₗ}, S_{ff}∈ [symbol] ^{2N}^{_{f}}^{×2N}^{_{f}} and S_{fl}∈ [symbol] ^{2N}^{ₗ}^{×2N}^{_{f}}

Let

$$η = {[ \begin{matrix}{η}_{1}^{T} & {η}_{2}^{T} & … & {η}_{N}^{T}\end{matrix} ]}^{T} = {[ \begin{matrix}{η}_{l}^{T} & {η}_{f}^{T}\end{matrix} ]}^{T} = ∈ {ℝ}^{2 N}$$

be a constant configuration. In view of the graph [symbol] , a nominal formation ( [symbol] , n) is formed. Afterward, the time-varying reference formation is:

$$q * ( t ) = [ {I}_{N} ⊗ A ( t ) ] η + {1}_{N} ⊗ b ( t ) \qquad ( 32 )$$

where A(t)∈ [symbol] ^{2×2} and b(t)∈ [symbol] ² are time-varying. The affine transformation of η can be achieved by specifying the entries of A(t) and b(t).

The affine image of η is defined by:

$$𝔸 ( η ) = \{ {q}^{`} ∈ {ℝ}^{2 N} : {q}^{`} = ( {I}_{N} ⊗ A ) η + {1}_{N} ⊗ b \} . \qquad ( 33 )$$

If q∈ [symbol] (η), the N agents acquire the affine formation maneuvers.

Definition 2. Affine localizability: If for any

$${q}^{`} = {[ \begin{matrix}{{q}^{`}}_{f}^{T} & {{q}^{`}}_{l}^{T}\end{matrix} ]}^{T} ∈ 𝒜 ( η ) , {{q}^{`}}_{l}$$

determine \grave{q}_{f}, then ( [symbol] , η) is affinely localizable by the leaders.

Assumption 3. The stress matrix S is positive semidefinite, and ran k(S)=N−dim−1 holds, where dim is the dimension of the systems in the Euclidean space. In this work, two-dimensional systems are considered, i.e., dim=2. This assumption implies that the matrix S_{ff} is positive definite and invertible.

By virtue of Definition 2 and Assumption 3, for any

$${q}^{`} = {[ \begin{matrix}{{q}^{`}}_{f}^{T} & {{q}^{`}}_{l}^{T}\end{matrix} ]}^{T} ∈ 𝒜 ( η ) ,$$

\grave{q}ₗ can uniquely determine

$${{q}^{`}}_{f}^{*}$$

as:

$${{q}^{`}}_{f}^{*} = - ( {S}_{ff}^{- 1} {S}_{fl} ⊗ {I}_{2} ) {{q}^{`}}_{l} . \qquad ( 34 )$$

where

$${q}_{f}^{*}$$

is the target position of the followers.

The aforementioned mathematics support an intelligent learning control method to ensure the safe formational maneuvering of a system of quadrotor UAVs and shield them against harmful cyber-attacks. Considering Assumption 2, the control of the leaders will not be considered. The distributed sliding mode surface of the followers' affine formation maneuver is designed as:

$${ζ}_{i} = {\sum }_{j = 1}^{N} {s}_{ij} ( {{q}^{{`}^{`}}}_{i} - {{q}^{{`}^{`}}}_{j} ) - {\sum }_{j = 1}^{N} {s}_{ij} ( {{q}^{{`}^{`}}}_{i} ( 0 ) - {{q}^{{`}^{`}}}_{j} ( 0 ) ) , \\ i ∈ {𝒱}_{f} + {Γ}_{1} {\sum }_{j = 1}^{N} {s}_{ij} ( {{q}^{`}}_{i} - {{q}^{`}}_{j} ) + {Γ}_{2} {\int }_{0}^{t} {s}_{ij} ( {Ξ}_{i} - {Ξ}_{j} ) dt \qquad ( 35 )$$

where Γ₁>0, Γ₂>0 are constant diagonal matrices, the function Ξᵢ(t) is designed as:

$${Ξ}_{i} ( t ) = [ {\sum }_{j = 1}^{N} {s}_{ij} {tanh}^{{ι}_{1}} ( {{q}^{`}}_{i} - {{q}^{`}}_{j} ) + {\sum }_{j = 1}^{N} {s}_{ij} ( {{q}^{{\to }^{`}}}_{i} - {{q}^{{\to }^{`}}}_{j} ) ] \qquad ( 36 )$$

where 1<ι₁<2, and ι₂>ι₁

The compact form of (35) can be expressed as:

$${ζ}_{f} = {{S}^{↼}}_{ff} ( {{𝓆}^{`}}_{f} - {q}_{f}^{*} ) - {{z}^{`}}_{f} ( 0 ) + {Γ}_{1} {z}_{f} + {Γ}_{2} {\int }_{0}^{t} {Ξ}_{f} dt \\ where \\ {z}_{f} = {{S}^{↼}}_{ff} ( {{q}^{`}}_{f} - {q}_{f}^{*} ) , {q}_{f}^{*} = - ( {S}_{ff}^{- 1} {S}_{fl} ⊗ {I}_{2} ) {{q}^{`}}_{l} \\ and \\ {{q}^{`}}_{f}^{*} = - ( {S}_{ff}^{- 1} {S}_{fl} ⊗ {I}_{2} ) {{q}^{{`}^{`}}}_{l} \qquad ( 37 )$$

represent the target formation of the followers and its first-order derivative, respectively, and

$${Ξ}_{f} = {[ \begin{matrix}{Ξ}_{{N}_{l} + 1}^{T} & {Ξ}_{{N}_{l} + 1}^{T} & … & {Ξ}_{{N}_{l} + {N}_{f}}^{T}\end{matrix} ]}^{T} .$$

The main objective here is to achieve:

$${lim}_{t \to ∞} ( {{q}^{`}}_{f} ( t ) - {q}_{f}^{*} ( t ) ) = 0 \qquad ( 38 )$$

Differentiating (37) with respect to time gives:

$$\begin{matrix}{{ζ}^{`}}_{f} = {{S}^{↼}}_{ff} ( {{q}^{{`}^{`}}}_{f} - {{q}^{`}}_{f}^{*} ) + {Γ}_{1} {{z}^{`}}_{f} + {Γ}_{2} {Ξ}_{f} \\ = {{S}^{↼}}_{ff} ( {Υ}_{f} + {φ}_{f} {u}_{f} - {{q}^{`}}_{f}^{*} + {Γ}_{1} {{S}^{↼}}_{ff}^{- 1} {{z}^{`}}_{f} + {Γ}_{2} {{S}^{↼}}_{ff}^{- 1} {Ξ}_{f} )\end{matrix} Where \\ {ζ}_{f} = [ \begin{matrix}{ζ}_{{N}_{l} + 1}^{T} & {ζ}_{{N}_{l} + 1}^{T} & … & {{ζ}_{{N}_{l} + {N}_{f}}^{T} ]}^{T}\end{matrix} , \\ {z}_{f} = [ \begin{matrix}{z}_{{N}_{l} + 1}^{T} & {z}_{{N}_{l} + 1}^{T} & … & {{z}_{{N}_{l} + {N}_{f}}^{T} ]}^{T}\end{matrix} , \\ {Υ}_{f} = {[ \begin{matrix}{Υ}_{{N}_{l} + 1}^{T} & {ϒ}_{{N}_{l} + 2}^{T} & … & {ϒ}_{{N}_{l} + {N}_{f}}^{T}\end{matrix} ]}^{T} , \\ {φ}_{f} = diag \{ \begin{matrix}{φ}_{{N}_{l} + 1} & {φ}_{{N}_{l} + 1} & … & {φ}_{{N}_{l} + {N}_{f}}\end{matrix} \} , \\ and \\ u = [ \begin{matrix}{u}_{{N}_{l} + 1}^{T} & {u}_{{N}_{l} + 2}^{T} & … & {{u}_{{N}_{l} + {N}_{f}}^{T} ]}^{T}\end{matrix} . \qquad ( 39 )$$

From (35), it is known that ζᵢ=[ζₓᵢζ_{yi}]^{T}. Then, a barrier Lyapunov function for the tracking error system (39) is defined as follows:

$${L}_{1} = Trace ( {{S}^{↼}}_{ff}^{- 1} {\sum }_{i = {N}_{l} + 1}^{{N}_{l} + {N}_{f}} \frac{1}{2} ( \frac{{c}_{x i}^{2}}{{c}_{x i}^{2} - {ζ}_{x i}^{2}} + \frac{{c}_{y i}^{2}}{{c}_{y i}^{2} - {ζ}_{y i}^{2}} ) ) \qquad ( 40 )$$

where cₓᵢ>0 and c_{yi}>0 are chosen to make sure that the states' constraints are not violated. From Remark 11 and Assumption 1, setting cₓᵢ=k_{ci}−Πᵢ and c_{yi}=k_{ci}−Πᵢ.

Differentiating L₁ with respect to time gives:

$$\begin{matrix}{{L}^{`}}_{1} = Trace ( {\overline{S}}_{ff}^{- 1} {\sum }_{i = {N}_{l} + 1}^{{N}_{l} + {N}_{f}} ( \frac{{ζ}_{x i} {ζ}_{x i}}{{c}_{x i}^{2} - {ζ}_{x i}^{2}} + \frac{{ζ}_{y i} {ζ}_{y i}}{{c}_{y i}^{2} - {z}_{y i}^{2}} ) ) \\ = Trace ( {\overline{S}}_{ff}^{- 1} {\sum }_{i = {N}_{l} + 1}^{{N}_{l} + {N}_{f}} ( [ \frac{{ζ}_{x i}}{{c}_{x i}^{2} - {ζ}_{x i}^{2}} \frac{{ζ}_{y i}}{{c}_{y i}^{2} - {ζ}_{y i}^{2}} ] [ \begin{matrix}{{ζ}^{`}}_{x i} \\ {{ζ}^{`}}_{y i}\end{matrix} ] ) ) \\ = Trace ( {\overline{S}}_{ff}^{- 1} {\sum }_{i = {N}_{l} + 1}^{{N}_{l} + {N}_{f}} {O}_{i}^{T} {{ζ}^{`}}_{i} ) \\ where {O}_{i} = {[ \frac{{ζ}_{x i}}{{c}_{x i}^{2} {ζ}_{x i}^{2}} \frac{{ζ}_{y i}}{{c}_{y i}^{2} - {ζ}_{y i}^{2}} ]}^{T}\end{matrix} \qquad ( 41 )$$

Equation (41) can be rewritten as:

$$\begin{matrix}{{L}^{`}}_{1} = Trace ( {O}_{f}^{T} {\overline{S}}_{ff}^{- 1} {{ζ}^{`}}_{f} ) \\ = {O}_{f}^{T} ( {Υ}_{f} + {φ}_{f} {u}_{f} - {{q}^{`}}_{f}^{*} + {Γ}_{I} {{S}^{↼}}_{ff}^{- 1} {{z}^{`}}_{f} + {Γ}_{2} {{S}^{↼}}_{ff}^{- 1} {Ξ}_{f} ) \\ where {O}_{f} = {[ {O}_{{N}_{l} + 1}^{T} {O}_{{N}_{l} + 2}^{T} … {O}_{{N}_{l} + {N}_{f}}^{T} ]}^{T} .\end{matrix} \qquad ( 42 )$$

The control protocol for the quadrotors with loss of direction resulting from an actuator attack can be designed as:

$$\begin{matrix}{{u}^{↼}}_{f} = {φ}_{f}^{- 1} ( \begin{matrix}{{Υ}^{`}}_{f} + {Γ}_{3} {ζ}_{f} + \frac{1}{2} {O}_{f} + {Γ}_{1} {{S}^{↼}}_{ff}^{- 1} {{z}^{`}}_{f} \\ + {Γ}_{2} {{S}^{↼}}_{ff}^{- 1} {Ξ}_{f} - {{S}^{↼}}_{ff}^{- 1} {{q}^{`}}_{f}^{*}\end{matrix} ) \\ {u}_{f} = N ( {ς}_{f} ) {{u}^{↼}}_{f} \\ {{ζ}^{`}}_{f} = {O}_{f}^{T} ( \begin{matrix}{{Υ}^{`}}_{f} + {Γ}_{3} {ζ}_{f} + \frac{1}{2} {O}_{f} + {Γ}_{1} {{S}^{↼}}_{ff}^{- 1} {{z}^{`}}_{f} \\ + {Γ}_{2} {{S}^{↼}}_{ff}^{- 1} {Ξ}_{f} - {{S}^{↼}}_{ff}^{- 1} {{q}^{`}}_{f}^{*}\end{matrix} )\end{matrix} \qquad ( 43 )$$

where Γ₃ is a constant positive definite diagonal matrix.

Remark 6. the control input [symbol] suffered from a loss of direction as a result of the attack gain Φ_{f}. The Nussbaum function N( [symbol] _{f}) is employed to tackle this problem. The control input u_{f} is the corrected signal.

Remark 7. The control protocol (43) cannot be applied to the quadrotors directly because of the loss of control direction and the unknown value of vector [symbol] .

The critic network is designed to assess the performance of the present control action and produce punishment/reward signals for adaptive learning. The critic network is designed using the neural network. A long-term cost function is defined as:

$$J ( t ) = {\int }_{c}^{∞} {e}^{\frac{τ - t}{a}} Λ ( τ ) d τ \qquad ( 44 )$$

$$where J = {[ {J}_{{N}_{l} + 1}^{T} {J}_{{N}_{l} + 1}^{T} … {J}_{{N}_{l} + {N}_{f}}^{T} ]}^{T} , α > 0$$

is a constant used to discount the future cost, Λ(t) is the current cost function expressed as:

$$Λ ( t ) = {ζ}_{f}^{T} Q {ζ}_{f} + {u}_{f}^{T} R {u}_{f} \qquad ( 45 )$$

where Q and R are constant positive definite matrices.

The long-term cost function (44) contains future system information coupled with the compromised variables, so the solution is difficult to calculate. Thus, the critic neural network will be deployed to approximate J as

$$J = {W}_{c}^{T} {Θ}_{c} ( {χ}_{c} ) + {ε}_{c} \qquad ( 46 )$$

The critic neural network estimate of J is given by:

$${J}^{`} = {{W}^{`}}_{c}^{T} {Θ}_{c} ( {χ}_{c} ) \qquad ( 47 )$$

where \grave{W}_{c} is the weight estimate of W_{c}.

The continuous-time temporal difference error is obtained as:

$${c}_{} ( t ) = Λ ( t ) - \frac{1}{α} {J}^{`} ( t ) + {{J}^{`}}^{`} ( t ) \qquad ( 48 )$$

For large α, i.e α→∞, (48) simplifies to:

$${c}_{} ( t ) = Λ ( t ) + {{J}^{`}}^{`} ( t ) = Λ ( t ) + ∇ {J}^{`} ( t ) {{χ}^{`}}_{c} \qquad ( 49 )$$

where ∇ stands for the gradient operator.

Define the temporal difference error objective function as:

$${E}_{c} = \frac{1}{2} {c}_{T}^{} {c}_{} \qquad ( 50 )$$

The weight update rule of the critic network is derived as follows:

$$\begin{matrix}{{{W}^{`}}^{`}}_{c} = - {σ}_{c} \frac{\partial {E}_{c}}{\partial {W}_{c}} = - {σ}_{c} {c}_{} ( t ) \frac{\partial {c}_{}}{\partial {W}_{c}} \\ = - {σ}_{c} {c}_{} ( t ) \frac{\partial [ Λ ( t ) - ( 1 / α ) {J}^{`} ( t ) + {J}^{`} ( t ) ]}{\partial {W}_{c}} \\ = - {σ}_{c} {c}_{} ( t ) [ - \frac{1}{α} \frac{\partial {J}^{`}}{\partial {W}_{c}} + \frac{\partial }{\partial {W}_{c}} ( \frac{\partial {J}^{`}}{\partial {χ}_{c}} ) ] \\ = - {σ}_{c} ( Λ ( t ) + {W}_{C}^{T} β ) β\end{matrix} \qquad ( 51 )$$

where σ_{c}>0 is the learning rate,

$$β = - \frac{{Θ}_{c}}{α} + ∇ {Θ}_{c} {{χ}^{`}}_{c} .$$

Design a Lyapunov function L_{c} for the critic network as:

$${L}_{c} = \frac{1}{2} {{W}^{`}}_{C}^{T} {{W}^{`}}_{c} \qquad ( 52 )$$

Using (51) and (52), one gets:

$$\begin{matrix}{{L}^{`}}_{c} = {{W}^{`}}_{c}^{T} {{W}^{{`}^{`}}}_{c} = {{W}^{`}}_{c}^{T} {{W}^{{`}^{`}}}_{c} \\ = - {σ}_{c} {{W}^{`}}_{c}^{T} ( Λ ( t ) + {W}_{c}^{T} β ) β\end{matrix} \qquad ( 53 )$$

At the end of the reinforcement learning, the weight update law (51) will minimize the objective function (50) such that [symbol] _{c}→0 and

$$\frac{J}{α} - j .$$

It follows that:

$$\begin{matrix}Λ ( t ) = {W}_{c}^{T} \frac{{Θ}_{c}}{α} + \frac{{ε}_{c}}{α} - ∇ I {{χ}^{`}}_{c} \\ = {W}_{c}^{T} \frac{{Θ}_{c}}{α} + \frac{{ε}_{c}}{α} - ∇ ( {W}_{c}^{T} {Θ}_{c} ( {χ}_{c} ) + {ε}_{c} ) {{χ}^{`}}_{c} \\ = - {W}_{c}^{T} β + {ϵ}_{c}\end{matrix} \qquad ( 54 )$$

where ϵ_{c}=ε_{c}+∇ε_{c}\grave{χ}_{c}, ∥ε_{c}∥≤ϵ_{c,max}, with >0 being the upper-bound.

Putting (54) into (53), one achieves:

$$\begin{matrix}{{L}^{`}}_{c} = - {σ}_{c} {{W}^{`}}_{c}^{T} ( {{W}^{`}}_{c} {Θ}_{c} + {ϵ}_{c} ) β \\ = - {σ}_{c} {β}^{T} β {{W}^{`}}_{c}^{T} {{W}^{`}}_{c} - {σ}_{c} {{W}^{`}}_{c}^{T} {ϵ}_{c} β \\ \leq - \frac{{σ}_{c} {β}^{T} β}{2} {{W}^{`}}_{c}^{T} {{W}^{`}}_{c} + \frac{{σ}_{c}}{2} {ϵ}_{c}^{T} {ϵ}_{c} \\ \leq - \frac{{σ}_{c} {β}^{T} β}{2} {{W}^{`}}_{c}^{T} {{W}^{`}}_{c} + \frac{{σ}_{c}}{2} {‖ {ϵ}_{c , m ax} ‖}^{2}\end{matrix} \qquad ( 55 )$$

Therefore, (55) represents a Lyapunov function for the critic network which has been modified by the weight update law (51) to minimize the objective function (50). This function (55) may be utilized by the actor-critic learning scheme to protect the UAVs from external disturbances, sensor deception attacks, and injection attacks on the actuators.

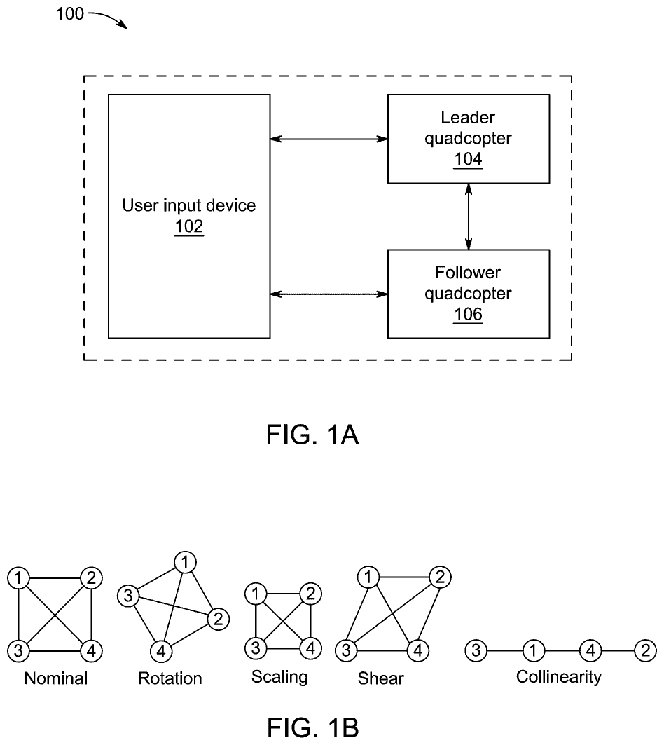

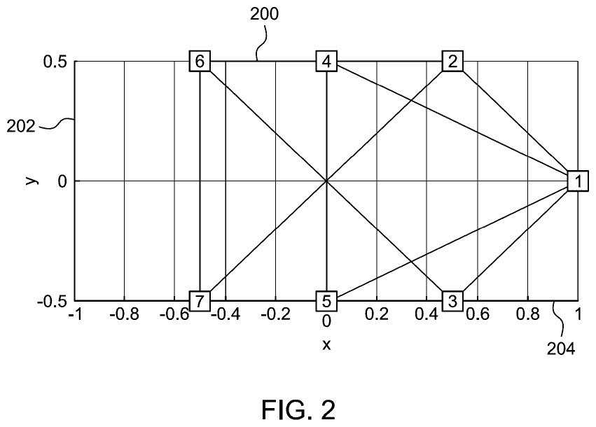

FIG. 1A depicts a block diagram of a system 100 for controlling a plurality of quadcopters, according to certain embodiments. The system 100 includes a user input device 102, a leader quadcopter 104, and a follower quadcopter 106. The user input device 102 is configured to receive a flight instruction from a user and deliver the flight instruction to a leader quadcopter. The leader quadcopter 104 is configured to receive a flight instruction from a user input device, calculate a leader formation maneuver, calculate a follower formation maneuver with a leader-follower formation controller configured to use affine transformations and stress matrices to calculate the follower formation maneuver, and communicate the follower formation maneuver to a follower quadcopter and execute the leader formation maneuver. The leader quadcopter 104 is a multirotor drone with four arms or booms, each with a rotor. Multirotor drones are unmanned aerial vehicles (UAV) with multiple rotors that are used to generate lift to enable the aircraft to fly. The follower quadcopter 106 is configured to receive the follower formation maneuver and execute the follower formation maneuver. In an implementation, the leader-follower formation controller is further configured to use an actor-critic machine learning algorithm to calculate the follower formation maneuver.

In the actor-critic control scheme, information about the lumped function [symbol] is unavailable due to the existence of cyber-attacks, unknown external disturbances, and uncertain dynamics. The actor neural network may be deployed to approximate [symbol] as follows:

$${Υ}_{f} = {W}_{a}^{T} {Θ}_{c} ( {χ}_{a} ) + {ε}_{a} \qquad ( 56 )$$

The actor network's estimation of [symbol] is thus:

$${{Υ}^{`}}_{f} = {{W}^{`}}_{a} {Θ}_{a} ( {χ}_{a} ) \qquad ( 57 )$$

The current weight estimation error of the actor network is:

$${{Υ}^{`}}_{f} = {{W}^{`}}_{a}^{T} {S}_{a} ( {χ}_{a} ) \qquad ( 58 )$$

where \grave{W}ₐ=W_{A}−\grave{W}ₐ.

Let J_{d}=0 be the desired cos-to-go in the actor network. The error between \grave{J} and J_{d} is:

$${{J}^{`}}_{d} = {J}^{`} - {J}_{d} = {J}^{`} \qquad ( 59 )$$

The total of the errors in the actor system is expressed as:

$${ϱ}_{a} = {{Υ}^{`}}_{f} + {K}_{a} {J}^{`} \qquad ( 60 )$$

$${{{W}^{`}}^{`}}_{a} = - {σ}_{a} \frac{\partial {E}_{a}}{\partial {W}_{a}} \qquad ( 61 )$$

where Kₐ is a diagonal gain matrix. The weight update law of the actor network,
where σₐ>0 is the learning rate, is:

$${E}_{a} = \frac{1}{2} {ϱ}_{a}^{T} {ϱ}_{a} \\ \frac{\partial {E}_{a}}{\partial {{W}^{`}}_{a}} = \frac{\partial {E}_{a}}{\partial {ϱ}_{a}} \frac{\partial {ϱ}_{a}}{\partial {{Υ}^{`}}_{f}} \frac{\partial {{Υ}^{`}}_{f}}{\partial {{W}^{`}}_{a}} = ( {{Υ}^{`}}_{f} + {K}_{a} {J}^{`} ) {Θ}_{a}$$

Because [symbol] is unknown, the weight update law is rewritten as:

$${{{W}^{`}}^{`}}_{a} = - {σ}_{a} ( {{W}^{`}}_{a}^{T} {Θ}_{a} ( {χ}_{a} ) + {K}_{a} {J}^{`} ) {Θ}_{a} \qquad ( 62 )$$

A candidate Lyapunov function for the actor-network is selected as follows:

$${L}_{a} = \frac{1}{2} {{W}^{`}}_{a}^{T} {{W}^{`}}_{a} \qquad ( 63 )$$

The time-derivative of Lₐ yields:

$${{L}^{`}}_{a} = - {σ}_{a} {{W}^{`}}_{a}^{T} {Θ}_{a} ( {{W}^{`}}_{a}^{T} {Θ}_{a} ( {χ}_{a} ) + {K}_{a} {J}^{`} ) \qquad ( 64 )$$

Considering that \grave{J}=W_{c}^{T}Θ_{c}(χ_{c})+\grave{W}_{c}^{T}Θ_{c}(χ_{c}), gets:

$${{J}^{`}}^{T} {J}^{`} \leq 2 {( {W}_{c}^{T} {Θ}_{c} )}^{T} {W}_{c} {Θ}_{c} + 2 {( {{W}^{`}}_{c}^{T} {Θ}_{c} )}^{T} {{W}^{`}}_{c}^{T} {Θ}_{c} \qquad ( 65 )$$

Inserting (65) into (64):

$$\begin{matrix}{{L}^{`}}_{a} = - {σ}_{a} {{W}^{`}}_{a}^{T} {Θ}_{a} ( {W}_{a}^{T} {Θ}_{a} ( {χ}_{a} ) - {{W}^{`}}_{a}^{T} {Θ}_{a} ( {χ}_{a} ) + {K}_{a} {J}^{`} ) \\ = - {σ}_{a} {{W}^{`}}_{a}^{T} {Θ}_{a} {W}_{a}^{T} {Θ}_{a} ( {χ}_{a} ) + {σ}_{a} {{‖ W}^{`}}_{a} {‖}^{2} {‖ {θ}_{a} ‖}^{2} \\ - {σ}_{a} {{W}^{`}}_{a}^{T} {Θ}_{a} {K}_{c} {J}^{`} \\ \leq - {σ}_{a} {{W}^{`}}_{a}^{T} {Θ}_{a} {W}_{a}^{T} {Θ}_{a} ( {χ}_{a} ) + {σ}_{a} {‖ {{W}^{`}}_{a} ‖}^{2} {‖ {Θ}_{a} ‖}^{2} \\ - \frac{{σ}_{a}}{2} {‖ {{W}^{`}}_{a} ‖}^{2} {‖ {Θ}_{a} ‖}^{2} + \frac{{σ}_{a}}{2} {K}_{a}^{T} {K}_{a} ‖ {J}^{`} ‖ {‖}^{2} \\ \leq - \frac{{σ}_{a}}{2} {‖ {{W}^{`}}_{a} ‖}^{2} {‖ {Θ}_{a} ‖}^{2} + \frac{{σ}_{a}}{2} {‖ {W}_{a} ‖}^{2} {‖ {Θ}_{a} ‖}^{2} \\ - \frac{{σ}_{a}}{2} {‖ {{W}^{`}}_{a} ‖}^{2} {‖ {Θ}_{a} ‖}^{2} \\ + {σ}_{a} {K}_{a}^{T} {K}_{a} ( {‖ {W}_{c} ‖}^{2} {‖ {Θ}_{c} ‖}^{2} + {‖ {{W}^{`}}_{c} ‖}^{2} {‖ {Θ}_{c} ‖}^{2} )\end{matrix} \qquad ( 66 )$$

Using the actor estimation in (57), (43) becomes:

$$\begin{matrix}{{u}^{↼}}_{f} = {φ}_{f}^{- 1} ( \begin{matrix}{{W}^{`}}_{a}^{T} {Θ}_{a} ( {χ}_{a} ) + {Γ}_{3} {ζ}_{f} + \frac{1}{2} {O}_{f} + {Γ}_{1} {{S}^{↼}}_{ff}^{- 1} {{z}^{`}}_{f} + \\ {Γ}_{2} {{S}^{↼}}_{ff}^{- 1} {Ξ}_{f} - {{S}^{↼}}_{ff}^{- 1} {{q}^{`}}_{f}^{*}\end{matrix} ) \\ {u}_{f} = N ( {ς}_{f} ) {{u}^{↼}}_{f} \\ {{ζ}^{`}}_{f} = {O}_{f}^{T} ( \begin{matrix}{{W}^{`}}_{a}^{T} {Θ}_{a} ( {χ}_{a} ) + {Γ}_{3} {ζ}_{f} + \frac{1}{2} {O}_{f} + \\ {Γ}_{1} {{S}^{↼}}_{ff}^{- 1} {{z}^{`}}_{f} + {Γ}_{2} {{S}^{↼}}_{ff}^{- 1} {Ξ}_{f} - {{S}^{↼}}_{ff}^{- 1} {{q}^{`}}_{f}^{*}\end{matrix} )\end{matrix} \qquad ( 67 )$$

Equation (42) can be evaluated as follows:

$$\begin{matrix}{{L}^{`}}_{1} = {O}_{f}^{T} {{ζ}^{`}}_{f} = {{ζ}^{`}}_{f} - {{ζ}^{`}}_{f} + {O}_{f}^{T} {φ}_{f} {u}_{f} \\ + {O}_{f}^{T} ( \begin{matrix}{W}_{a}^{T} ( {Θ}_{a} {χ}_{a} ) + {ε}_{a} - {{q}^{`}}_{f}^{*} + {Γ}_{1} {{S}^{↼}}_{ff}^{- 1} {{z}^{`}}_{f} + \\ {Γ}_{2} {{S}^{↼}}_{ff}^{- 1} {Ξ}_{f}\end{matrix} ) \\ = {{S}^{`}}_{f} + {φ}_{f} N ( {ϛ}_{f} ) {{S}^{`}}_{f} \\ + {O}_{f}^{T} ( \begin{matrix}{W}_{a}^{T} ( {Θ}_{a} {χ}_{a} ) + {ε}_{a} - {{q}^{`}}_{f}^{*} + {Γ}_{1} {{S}^{↼}}_{ff}^{- 1} {{z}^{`}}_{f} + \\ {Γ}_{2} {{S}^{↼}}_{ff}^{- 1} {Ξ}_{f}\end{matrix} ) \\ - {O}_{f}^{T} ( \begin{matrix}{{W}^{`}}_{a}^{T} {Θ}_{a} ( {χ}_{a} ) + {Γ}_{3} {ζ}_{f} + \frac{1}{2} {O}_{f} + \\ {Γ}_{1} {{S}^{↼}}_{ff}^{- 1} {{z}^{`}}_{f} + {Γ}_{2} {{S}^{↼}}_{ff}^{- 1} - {{S}^{↼}}_{ff}^{- 1} {{q}^{`}}_{f}^{*}\end{matrix} ) \\ = - {O}_{f}^{T} {Γ}_{3} {ζ}_{f} - \frac{1}{2} {O}_{f}^{T} {O}_{f} + {O}_{f}^{T} {{W}^{`}}_{a}^{T} {Θ}_{a} ( {χ}_{a} ) b \\ + {O}_{f}^{T} {ε}_{a} + [ {φ}_{f} N ( {ϛ}_{f} ) + 1 ] {{ζ}^{`}}_{f}\end{matrix} \qquad ( 68 )$$

Consider the following Young's inequalities:

$${O}_{f}^{T} {ε}_{a} \leq \frac{π {o}_{f}^{T} {o}_{f}}{2} + \frac{{ε}_{a}^{T} {ε}_{a}}{2 ϖ} \qquad ( 69 )$$

$$- {O}_{f}^{T} {{W}^{`}}_{a}^{T} {Θ}_{a} ( {χ}_{a} ) \leq \frac{ϖ {o}_{f}^{T} {o}_{f}^{T}}{2} + \frac{{W}_{a}^{T} {Θ}_{a} {Θ}_{a}^{T} {W}_{a}}{2 ϖ} \qquad ( 70 )$$

where ω̅>0 is a constant.

Using the inequalities above, (68) gives:

$$\begin{matrix}{{L}^{`}}_{1} \leq - {O}_{f}^{T} {Γ}_{3} {ζ}_{f} + {O}_{f}^{T} {O}_{f} ( ϖ - \frac{1}{2} ) + \frac{{{W}^{`}}_{a}^{T} {Θ}_{a} {Θ}_{a}^{T} {{W}^{`}}_{a}}{2 ϖ} \\ + \frac{{ε}_{a}^{T} {ε}_{a}}{2 ϖ} + [ {φ}_{f} N ( {ς}_{f} ) + 1 ] {{ζ}^{`}}_{f}\end{matrix} \qquad ( 71 )$$

For

$$ϖ = \frac{1}{2} : \\ \begin{matrix}{{L}^{`}}_{1} \leq - {λ}_{m i n} ( {Γ}_{3} ) {\sum }_{i = {N}_{l} + 1}^{{N}_{l} + {N}_{f}} ( \frac{{ζ}_{xi}^{2}}{{c}_{xi}^{2} - {ζ}_{xi}^{2}} + \frac{{ζ}_{yi}^{2}}{{c}_{yi}^{2} - {ζ}_{yi}^{2}} ) \\ + \frac{{‖ {{W}^{`}}_{a} ‖}^{2} {‖ {Θ}_{a} ‖}^{2}}{2 ϖ} + \frac{{‖ {ε}_{a} ‖}^{2}}{2 ϖ} + [ {φ}_{f} N ( {ς}_{f} ) + 1 ] {{ζ}^{`}}_{f}\end{matrix} \qquad ( 72 )$$

The scheme ensures that the negative effects of the cyber-attacks are diminished because the state constraints are not violated, and the quadrotors maintain operation within the safety boundaries and the tracking errors in the closed-loop system are bounded within a compact set. The leader-follower affine formation maneuver of the quadrotors is therefore realized.

The control scheme is proved by choosing a Lyapunov function candidate as follows:

$$L = {L}_{1} + {L}_{a} + {L}_{c} \qquad ( 73 )$$

By differentiating L with respect to time:

$$\begin{matrix}{L}^{`} \leq - {λ}_{m i n} ( {Γ}_{3} ) {\sum }_{i = {N}_{l} + 1}^{{N}_{l} + {N}_{f}} ( \frac{{ζ}_{xi}^{2}}{{c}_{xi}^{2} - {ζ}_{xi}^{2}} + \frac{{ζ}_{yi}^{2}}{{c}_{yi}^{2} - {ζ}_{yi}^{2}} ) \\ - {‖ {{W}^{`}}_{a} ‖}^{2} {‖ {Θ}_{a} ‖}^{2} ( {σ}_{a} - \frac{1}{2 ϖ} ) \\ - {‖ {{W}^{`}}_{c} ‖}^{2} ( \frac{{σ}_{c}}{2} {‖ β ‖}^{2} - {σ}_{a} {‖ {K}_{a} ‖}^{2} {‖ {Θ}_{c} ‖}^{2} ) \\ + {σ}_{a} {‖ {K}_{a} ‖}^{2} {‖ {W}_{c} ‖}^{2} {‖ {Θ}_{c} ‖}^{2} + \frac{{σ}_{a}}{2} ‖ {{W}_{a}}^{2} ‖ {‖ {Θ}_{a} ‖}^{2} \\ + \frac{{σ}_{c}}{2} {‖ {ϵ}_{c , m ax} ‖}^{2} + \frac{{‖ {ε}_{a} ‖}^{2}}{2 ϖ} + [ {φ}_{f} N ( {ζ}_{f} ) + 1 ] {{ζ}^{`}}_{f}\end{matrix} \qquad ( 74 )$$

Based on Lemma 3:

$$log [ \frac{{c}_{xi}^{2}}{{c}_{xi}^{2} - {ζ}_{xi}^{2}} ] \leq \frac{{ζ}_{xi}^{2}}{{c}_{xi}^{2} - {ζ}_{xi}^{2}} \qquad ( 75 )$$

$$log [ \frac{{c}_{yi}^{2}}{{c}_{yi}^{2} - {ζ}_{yi}^{2}} ] \leq \frac{{ζ}_{yi}^{2}}{{c}_{yi}^{2} - {ζ}_{yi}^{2}} \qquad ( 76 )$$

Equation (75) can be simplified as:

$${L}^{`} \leq {h}_{1} L + {h}_{2} + [ {φ}_{f} N ( {ς}_{f} ) + 1 ] {{S}^{`}}_{f} where \\ \begin{matrix}{h}_{1} = min ( \begin{matrix}2 {λ}_{m i n} ( {Γ}_{3} ) , 2 {‖ {Θ}_{a} ‖}^{2} ( {σ}_{a} - \frac{1}{2 σ} ) ) \\ 2 ( \frac{{σ}_{c}}{2} {‖ β ‖}^{2} - {σ}_{a} {‖ {K}_{a} ‖}^{2} {‖ {Θ}_{c} ‖}^{2} )\end{matrix} ) \\ {h}_{2} = {σ}_{a} {‖ {K}_{a} ‖}^{2} {‖ {W}_{c} ‖}^{2} {‖ {Θ}_{c} ‖}^{2} + \frac{{σ}_{a}}{2} {‖ {W}_{a} ‖}^{2} {‖ {Θ}_{a} ‖}^{2} \\ + \frac{{σ}_{c}}{2} {‖ {ϵ}_{c , ma x} ‖}^{2} + \frac{{‖ {ε}_{a} ‖}^{2}}{2 ϖ}\end{matrix} and ( {σ}_{a} - \frac{1}{2 ϖ} ) > 0 \\ ( \frac{{σ}_{c}}{2} {‖ β ‖}^{2} - {σ}_{a} {‖ {K}_{a} ‖}^{2} {‖ {Θ}_{c} ‖}^{2} ) > 0 \qquad ( 77 )$$

Integrating (78) over the interval [0 t] leads to:

$$L ( t ) \leq \frac{{h}_{2}}{{h}_{1}} + L ( 0 ) {e}^{- {h}_{1} t} + {e}^{- {h}_{1} t} {\int }_{0}^{t} [ N ( ϛ ) + 1 ] {ζ}^{`} {e}^{{h}_{1} τ} d τ \qquad ( 78 )$$

Selecting h₃ as the upper-bound of

$${e}^{- {h}_{1} t} {\int }_{0}^{t} [ N ( ϛ ) + 1 ] {s}^{`} {e}^{{h}_{1} τ} d τ$$

achieves:

$$L ( t ) \leq \frac{{h}_{2}}{{h}_{1}} + L ( 0 ) {e}^{- {h}_{1} t} + {h}_{3} \qquad ( 79 )$$

Based on the inequality above, the tracking error signals will, in the end, remain in the compact sets defined by:

$$‖ {ζ}_{xi} ‖ \leq {c}_{xi} \sqrt{1 - {e}^{- 2 ( \frac{{h}_{2 i}}{{h}_{1 i}} + {h}_{3 i} + {L}_{xi} ( 0 ) )}} \qquad ( 80 )$$

$$‖ {ζ}_{yi} ‖ \leq {c}_{yi} \sqrt{1 - {e}^{- 2 ( \frac{{h}_{2 i}}{{h}_{1 i}} + {h}_{3 i} + {L}_{yi} ( 0 ) )}} \qquad ( 81 )$$

$$‖ {\tilde{W}}_{a} ‖ \leq \sqrt{2 ( \frac{{h}_{2}}{{h}_{1}} + {h}_{3} + L ( 0 ) )} \qquad ( 82 )$$

$$‖ {\tilde{W}}_{c} ‖ \leq \sqrt{2 ( \frac{{h}_{2}}{{h}_{1}} + {h}_{3} + L ( 0 ) )} \qquad ( 83 )$$

FIG. 1B illustrates several formation shape maneuvers of a plurality of quadcopters described in FIG. 1A. The formation shape maneuvers depicted in FIG. 1B are non-limiting examples of some of the possible affine formation maneuvers which may be joined in sequence to comprise the overall flight path of a plurality of quadcopters.

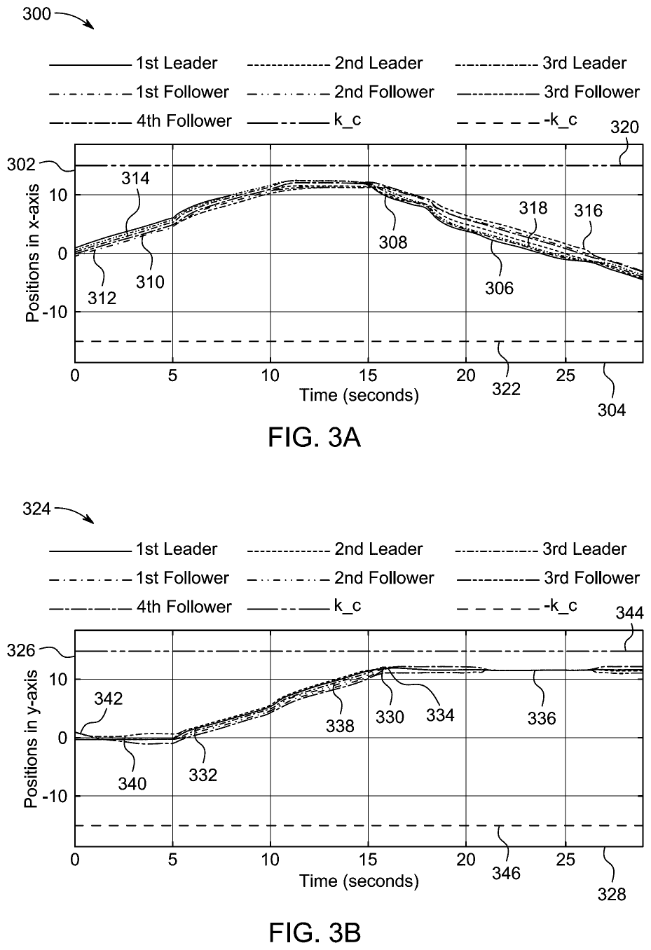

FIG. 2 depicts a nominal formation of the quadrotors 200, according to certain embodiments. The nominal formation 200 is a two-dimensional plot of the position of the quadcopters along the y-axis 202 versus time along the x-axis 204.

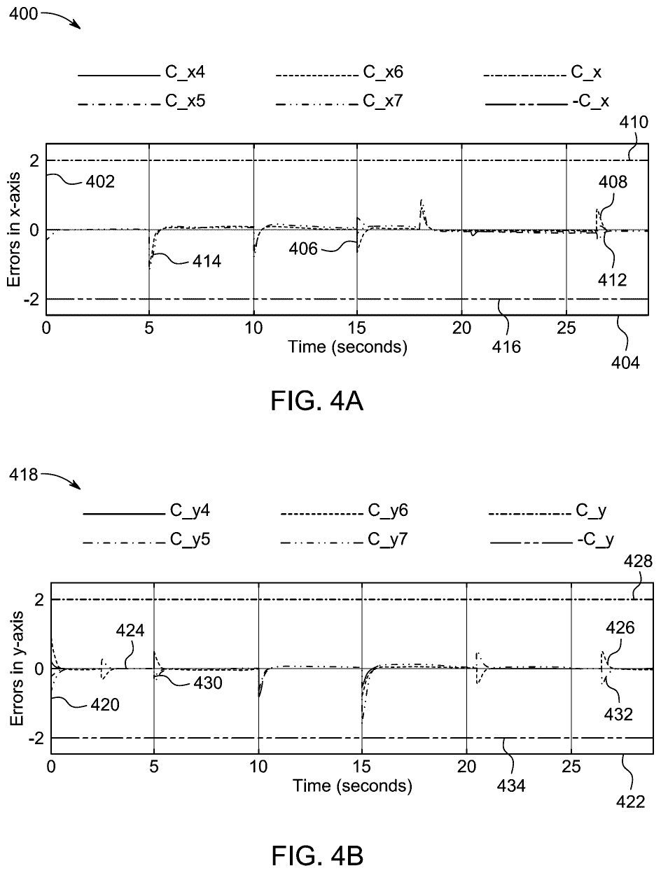

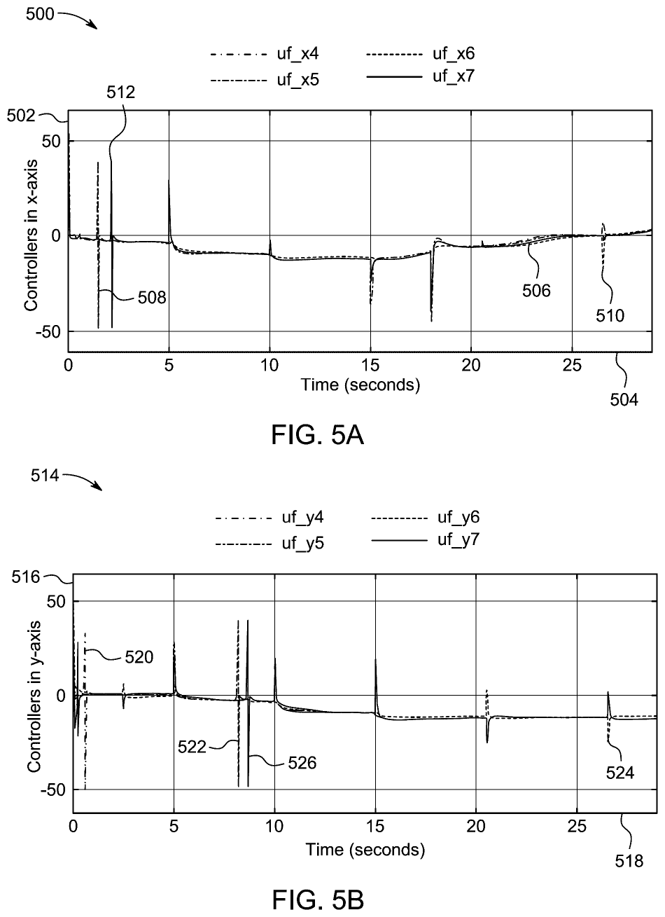

FIG. 3A depicts a graph 300 of leader-follower position trajectories in the x-axis over time, according to certain embodiments. FIG. 3B depicts the graph 324 of leader-follower position trajectories in the y-axis over time, according to certain embodiments. FIG. 3A shows the graph 300 obtained by plotting position trajectories along the y-axis 302 and time along x-axis 304 and includes curves of first leader 306, second leader 308, third leader 310, first follower 312, second follower 314, third follower 316, fourth follower 318, k_c 320 and −k_c 322. FIG. 3B shows the graph 324 obtained by plotting position trajectories in the y-axis along y-axis 326 and time along x-axis 328 and includes curves of first leader 330, second leader 332, third leader 334, first follower 336, second follower 338, third follower 340, fourth follower 342, k_c 344 and −k_c 346. FIG. 3A-3B illustrate the leader-follower time-varying trajectories of the quadrotors under sensor deception attacks and actuator injection attacks. It can be seen that the learning-based controller of the present disclosure can keep the quadrotors within the safety region despite influence from cyberattacks. Here, simulations are given to highlight the validity of the developed control method. The nominal formation of the quadrotors 200 is depicted in FIG. 2. The formation group comprises three leaders (Nₗ=3) and four followers (N_{f}=4). The quadrotors tagged (1,2, &3) and (4,5,6&7) represent the groups of leaders and followers, respectively, with corresponding nominal positions given as η₁=[1 0], η₂=[0.5 0.5], η₃=[0.5 −0.5], η₄=[0 0.5], η₅=[0 −0.5], η₆=[−0.5 0.5] and η₇=[−0.5 −0.5] and

$$η = {[ {η}_{1}^{T} , {η}_{2}^{T} , … , {η}_{7}^{T} ]}^{T} .$$

The stress matrix [symbol] is computed:

$${S}^{↼} = [ \begin{matrix}{{S}^{↼}}_{ll} & {{S}^{↼}}_{lf} \\ {{S}^{↼}}_{fl} & {{S}^{↼}}_{ff}\end{matrix} ] \qquad ( 84 )$$

$$where$$

$${{S}^{↼}}_{fl} = [ \begin{matrix}0.1370 & - 0.5482 & 0 \\ 0.137 & 0 & - 0.5482 \\ 0 & 0 & 0.137 \\ 0 & 0.1370 & 0\end{matrix} ] ; \\ {{S}^{↼}}_{lf} = [ \begin{matrix}0.1370 & 0.1370 & 0 & 0 \\ - 0.5482 & 0 & 0 & 0.1370 \\ 0 & - 0.5482 & 0.1370 & 0\end{matrix} ] \\ {{S}^{↼}}_{ff} = [ \begin{matrix}0.7538 & - 0.0685 & - 0.2741 & 0 \\ - 0.0685 & 0.7538 & 0 & - 0.2741 \\ - 0.2741 & 0 & 0.2741 & - 0.1370 \\ 0 & - 0.2741 & - 0.1370 & 0.2741\end{matrix} ] ; \\ {{S}^{↼}}_{ll} = [ \begin{matrix}0.2742 & - 0.2741 & - 0.2741 \\ - 0.2741 & 0.6853 & 0 \\ - 0.2741 & 0 & 0.6853\end{matrix} ]$$

The initial positions of the quadrotors are set as q₁(0)=[1 0], q₂(0)=[0.5 1], q₃(0)=[0.5 −0.75], q₄(0)=[0 0.75], q₅(0)=[0 −0.75], q₆(0)=[−0.75 1.5] and q₇(0)=[−0.75 −1.25] and q(0)=[q₁(0)^{T}, q₂(0)^{T}, . . . , q₇(0)^{T}]^{T}. To enforce safety for the group of quadrotors, the motion of each quadrotor is constrained within the safety region such that |xᵢ|<k_{ci} and |yᵢ|<k_{ci}, with k_{ci}=15. It follows that the tracking errors are also constrained as |ζₓᵢ|<cₓᵢ and |yᵢ|<c_{yi}, with cₓᵢ=c_{yi}=2 to avoid violation of the safety region. The sensor deception attacks are modeled as φᵢ=(1+cos (t)), the actuator injection attacks are modeled as mᵢ=sin (qᵢ(t)\grave{q}ᵢ(t)). The controller gains are chosen as Γ₁=dia g 15,15, . . . ,15, Γ₂=diag 2,2, . . . ,2, Γ₃=diag 10,10, . . . ,10, ι₁=1.5, and ι₂=2.1. The parameters in the cost function are R=diag 5,5, . . . ,5, Q=diag 10,10, . . . ,10 and the discount factor α=0.2. When defining the reinforcement learning parameters 5 nodes are considered in both actor and critic neural networks; the learning rates of the actor and critic neural networks are σₐ=1.5 and σ_{c}=0.01, respectively; the centers of the Gaussian functions of both actor and critic networks are selected between −0.5 and 0.5, while the width of both functions are set as 0.25; and the initial weights of the actor and critic networks are selected as \grave{W}ₐᵢ(0)=\grave{W}_{ci}(0)=[0.5,0.5, . . . ,0.5]^{T}.

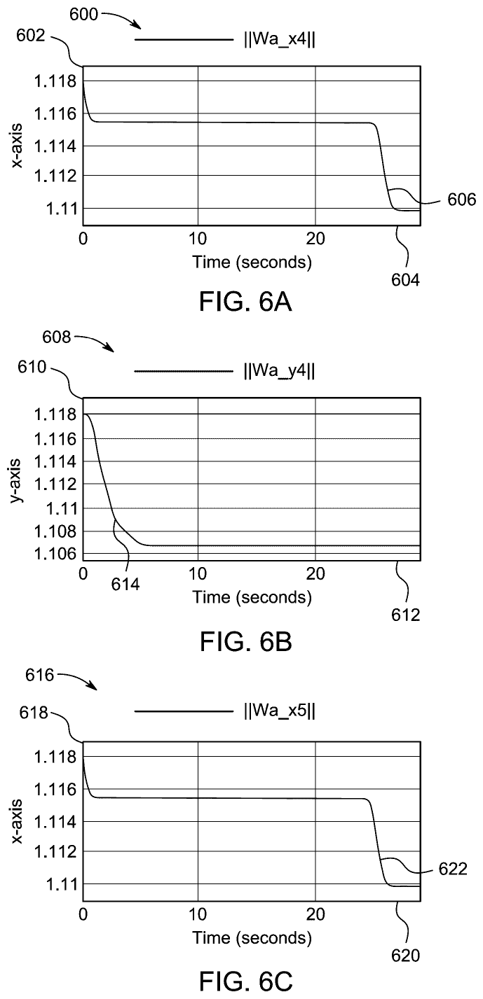

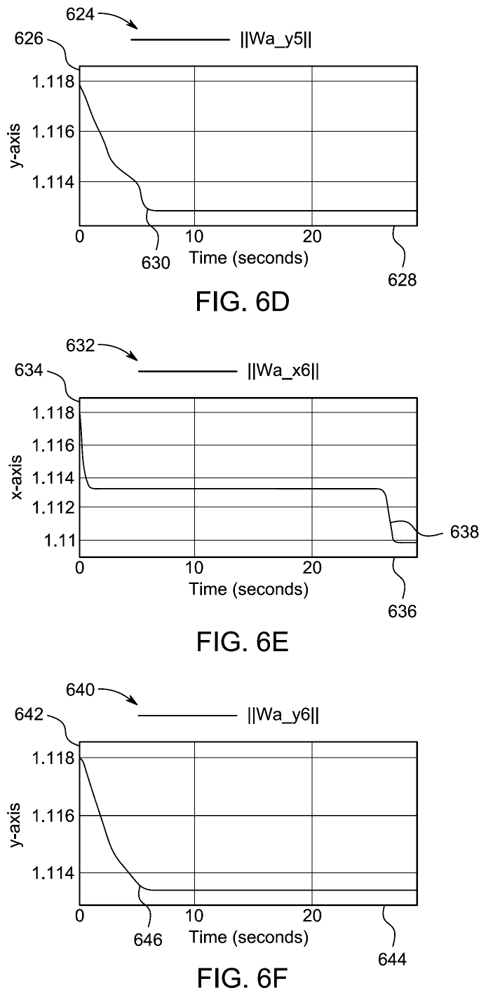

FIG. 4A depicts the graph 400 of tracking errors of followers in the x-axis, according to certain embodiments. FIG. 4B depicts the graph 418 of tracking errors of followers in the y-axis, according to certain embodiments. FIG. 4A shows the graph 400 obtained by plotting tracking errors in x-axis position along the y-axis 402 of the graph versus time in seconds along the x-axis 404 of the graph, and includes curves of C_x4 406, C_x6 408, C_x 410, C_x5 412, C_x7 414 and —C_x 416. FIG. 4B shows the graph 418 obtained by plotting tracking errors in y-axis position along the y-axis 420 of the graph and time in seconds along x-axis 422 of the graph and includes curves of C_y4 424, C_y6 426, C_y 428, C_y5 430, C_y7 430 and —C_y 432. Moreover, the leader-follower tracking errors did not violate the prescribed constraints, as depicted in FIG. 4.

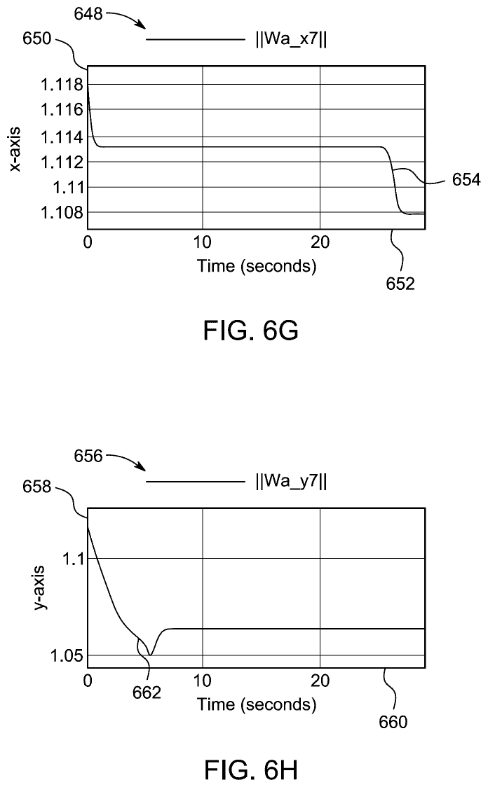

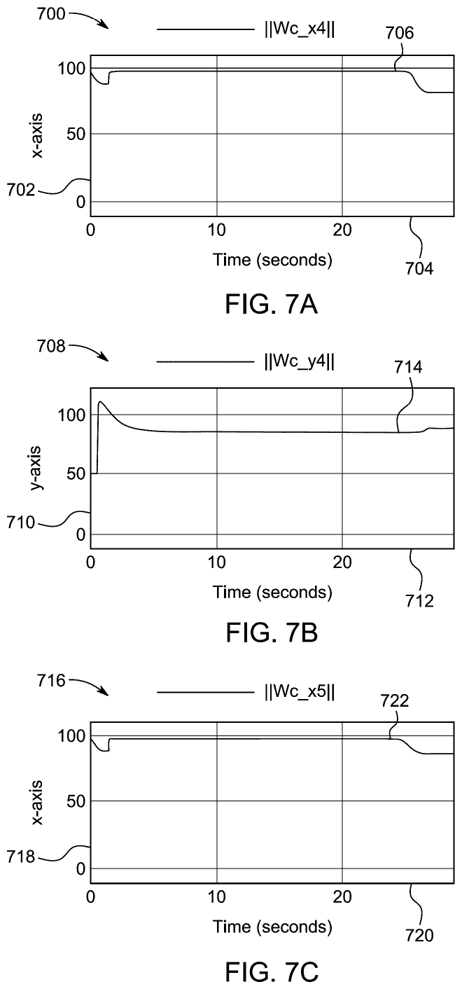

FIG. 5A depicts the graph 500 of actor-critic learning control protocols of followers in the x-axis, according to certain embodiments. FIG. 5B depicts graph 514 of actor-critic learning control protocols of followers in y-axis position, according to certain embodiments. FIG. 5A shows the graph 500 obtained by plotting controllers in the x-axis position along the y-axis 502 of the graph and time in seconds along the x-axis of the graph 504 and includes curves of uf_x4 506, uf_x5 508, uf_x6 510, and uf_x7 512. FIG. 5B shows the graph 514 obtained by plotting controllers in y-axis position 516 along the y-axis of the graph and time in seconds 518 along the x-axis of the graph and includes curves of uf_y4 520, uf_y5 522, uf_y6 524, and uf_y7 526. The responses of the actor-critic learning-based control protocols that aid the realization of the aforementioned control performance are depicted in FIG. 5.

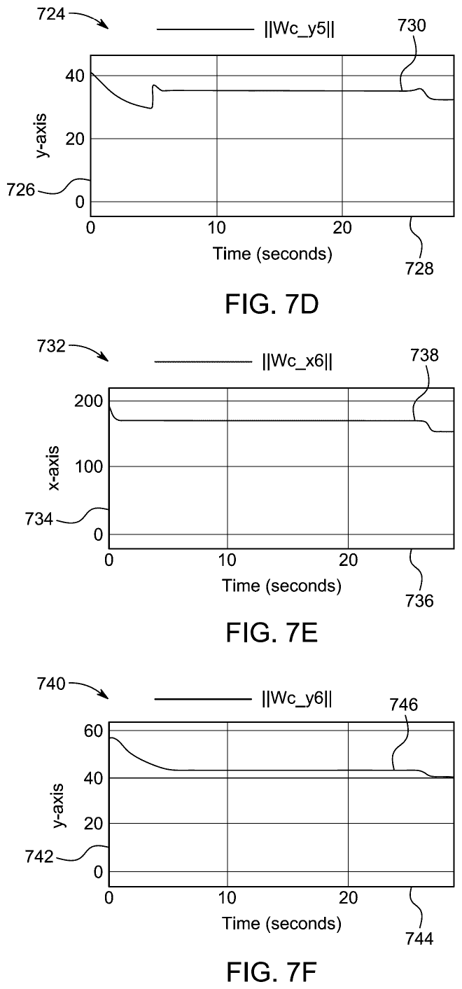

FIG. 6A-6H depict the graphs 600, 608, 616, 624, 632, 640, 648, 656 of Norm-2 of the actor weights, according to certain embodiments. FIG. 6A shows the graph 600 obtained by plotting x-axis weights along the y-axis 602 and time in seconds along the x-axis 604 and includes the curve of Wa_x4 606. FIG. 6B shows the graph 608 obtained by plotting x-axis weights along the y-axis 610 and time in seconds along x-axis 612 and includes the curve of Wa_x6 614. FIG. 6C shows the graph 616 obtained by plotting y-axis weights 618 along the y-axis and time in seconds 620 along x-axis and includes the curve of Wa_y4 622. FIG. 6D shows the graph 624 obtained by plotting y-axis weights along y-axis 626 and time in seconds along x-axis 628 and includes the curve of Wa_y6 630. FIG. 6E shows the graph 632 obtained by plotting x-axis weights along y-axis 634 and time in seconds along x-axis 636 and includes the curve of Wa_x5 638. FIG. 6F shows the graph 640 obtained by plotting x-axis weights along the y-axis 642 versus time in seconds along the x-axis 644 and includes the curve of Wa_x7 646. FIG. 6G shows the graph 648 obtained by plotting y-axis weights along the y-axis 650 versus time in seconds along x-axis 652 and includes the curve of Wa_y5 654. FIG. 6H shows the graph 656 obtained by plotting y-axis weights along the y-axis 658 versus time in seconds along x-axis 660 and includes the curve of Wa_y7 662. The evolution of the Norm-2 of the weight vectors of the actor and critic networks is depicted in FIGS. 6A-6H.

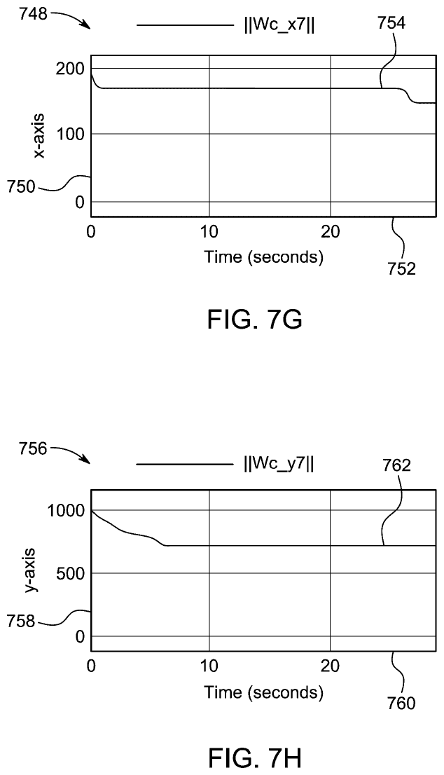

FIG. 7A-7H depicts the graphs 700, 708, 716, 724, 732, 740, 748, 756 of Norm-2 of the critical weights, according to certain embodiments. FIG. 7A shows the graph 700 obtained by plotting positions in the x-axis along the y-axis 702 versus time in seconds along the x-axis 704 and includes the curve of Wc_x4 706. FIG. 6B shows the graph 708 obtained by plotting the position in the x-axis along the y-axis 710 and time in seconds along the x-axis 712 and includes the curve of Wc_x6 714. FIG. 7C shows the graph 716 obtained by plotting position in the y-axis along the y-axis 718 and time in seconds along the x-axis 720 and includes the curve of the Wc_y4 722. FIG. 7D shows the graph 724 obtained by plotting the position in the y-axis along the y-axis 726 and time in seconds along the x-axis 728 and includes the curve of Wc_y6 730. FIG. 7E shows the graph 732 obtained by plotting the position in the x-axis along the y-axis 734 and time in seconds along the x-axis 736 and includes the curve of Wc_x5 738. FIG. 7F shows the graph 740 obtained by plotting the position in x-axis along the y-axis 742 and time in seconds the along x-axis 744 and includes the curve of Wc_x7 746. FIG. 7G shows the graph 748 obtained by plotting the position in the y-axis along the y-axis 750 and time in seconds along the x-axis 752 and includes the curve of Wc_y5 754. FIG. 7H shows the graph 756 obtained by plotting the position in the y-axis along the y-axis 758 versus time in seconds along the x-axis 760 and includes the curve of Wc_y7 762. The evolution of the Norm-2 of the weight vectors of the actor and critic networks is depicted in FIGS. 6A-6H and FIGS. 7A-7H, respectively.

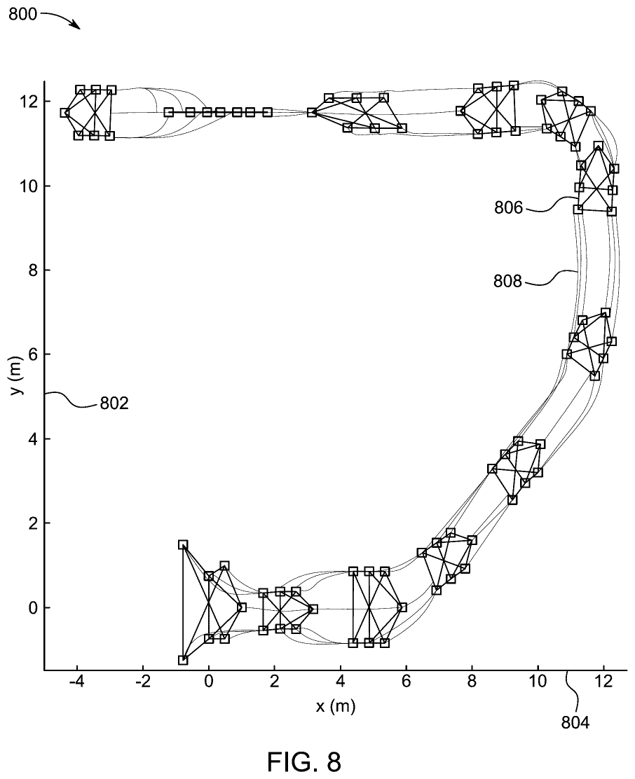

FIG. 8 depicts the graph 800 of leader-follower affine formation maneuvers, according to certain embodiments. The graph 800 is obtained by plotting y(m) along the y-axis 802 versus x(m) along the x-axis 804 and includes the curves of 806 and 808. The affine formation maneuvers of the leader-follower multiple-quadrotor system are shown in FIG. 8.

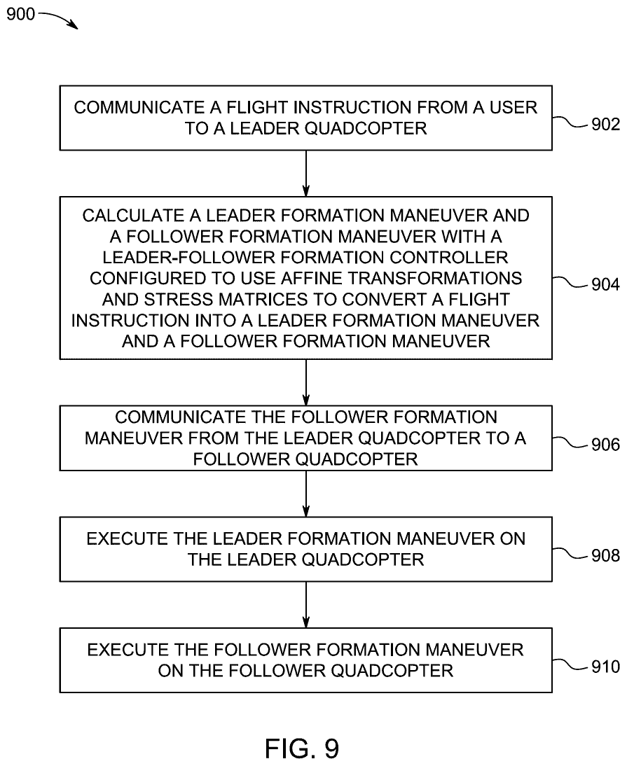

FIG. 9 depicts a flowchart 900 of a method for controlling the flight of a plurality of quadcopters, according to certain embodiments. At step 902, a flight instruction is communicated from a user to a leader quadcopter. At step 904, a leader formation maneuver and a follower formation maneuver are calculated with a leader-follower formation controller configured to use affine transformations and stress matrices to convert a flight instruction into a leader formation maneuver and a follower formation maneuver. At step 906, the follower formation maneuver is communicated from the leader quadcopter to a follower quadcopter. At step 908, the leader formation maneuver is executed on the leader quadcopter. At step 910, the follower formation maneuver is executed on the follower quadcopter. In an implementation, the leader-follower formation controller is further configured to utilize a barrier function to calculate the leader formation maneuver and the follower formation maneuver. In an implementation, the barrier function is a Lyapunov candidate function which trends to infinity at a predetermined constraint value. In an implementation, the leader-follower formation controller is further configured to use an actor-critic learning mechanism. In an implementation, the actor-critic learning mechanism is a machine learning algorithm. In an implementation, the leader-follower formation controller is further configured to use a distributed sliding mode control. In an implementation, the distributed sliding mode control is configured to use a control law to protect at least one of the plurality of quadcopters from a malicious cyber-attack. In an implementation, the malicious cyber-attack is a distributed denial of service attack, a sensor deception attack, or an actuator injection attack. In an implementation, the distributed sliding mode control is configured to use a Nussbaum gain function to mitigate the effects of input gain on the follower formation maneuver, the input gain being created a malicious cyber-attack. In an implementation, the follower formation maneuver comprises a scaling maneuver, a shearing maneuver, a translation maneuver, and a collinearity maneuver. In an implementation, the position of each of the plurality of quadcopters within the follower formation maneuver is defined by an x position, a y position, a z position, a roll angle, a yaw angle, and a pitch angle. In an implementation, the leader-follower formation controller is configured to use a radial basis function neural network to smooth a flight instruction after the flight instruction has been communicated from a user to a leader quadcopter.

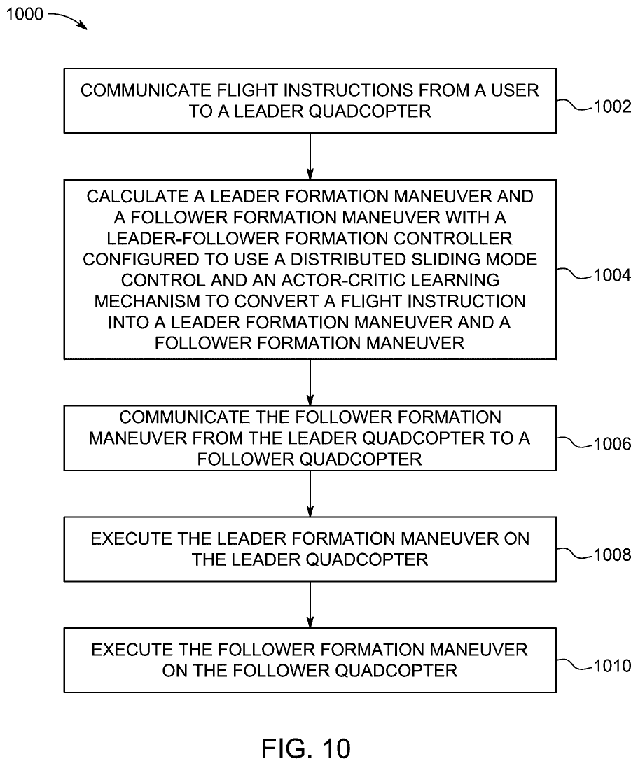

FIG. 10 depicts a flowchart 1000 of a method for controlling the flight of a plurality of quadcopters, according to certain other embodiments. At step 1002, flight instructions are communicated from a user to a leader quadcopter. At step 1004, a leader formation maneuver and a follower formation maneuver are calculated with a leader-follower formation controller configured to use a distributed sliding mode control and an actor-critic learning mechanism to convert a flight instruction into a leader formation maneuver and a follower formation maneuver. At step 1006, the follower formation maneuver is communicated from the leader quadcopter to a follower quadcopter. At step 1008, the leader formation maneuver is executed on the leader quadcopter. At step 1010, the follower formation maneuver is executed on the follower quadcopter. In an implementation, the sliding mode control is configured to convert the flight instruction into a follower formation maneuver with affine transformations and stress matrices. In an implementation, the actor-critic learning mechanism is a machine learning algorithm, and the machine learning algorithm is further configured to use a radial basis function to smooth a flight instruction after the flight instruction has been communicated from a user to a leader quadcopter. In an implementation, the sliding mode control and the actor-critic learning mechanism are configured to use a control law to protect at least one of the plurality of quadcopters from a malicious cyber-attack. In an implementation, the distributed sliding mode control and the actor-critic learning mechanism are configured to use a Nussbaum gain function to mitigate the effects of input gain on a follower formation maneuver, the input gain being created by a malicious cyber-attack. In an implementation, the malicious cyber-attack is a distributed denial of service attack, a sensor deception attack, or an actuator injection attack.

The present disclosure investigates the actor-critic learning-based affine formation maneuver controls of a group of quadrotor UAVs while considering safety constraints and providing security against cyber-attacks. The leaders specify desired formation maneuvers through stress matrices and an affine transformation scheme. By constructing a barrier Lyapunov function, the operation of quadrotor UAVs within a predefined safety range is guaranteed. A distributed sliding mode control coupled with an actor-critic learning mechanism is designed to counter cyber-attacks and achieve the leader-follower affine formation maneuvers of the quadrotor UAVs. The critic system is used to estimate the objective function of the system whereas the actor system takes the proper control action necessary to achieve control objectives. A Lyapunov stability function is employed to prove that the closed-loop system is bounded. The provided example reveals that the method and system of the present disclosure are able to meet the control objective. Compared with traditional systems wherein input gains induced by attack signals are not considered, the present disclosure addresses these problems by integrating the Nussbaum function into the controller. As such, the controller of the present disclosure does not require any prior information about the signs of the input gains induced by the attack signals.

In conventional methods and systems, learning-based controllers use linear quadratic regulators, in contrast the present disclosure teaches a distributed sliding mode control approach equipped with a learning mechanism. The learning mechanism may be a machine learning mechanism. A machine learning mechanism may be understood to be any formula, computer program, computer, computer system, program, network of computers, or the like, which is configured to develop, change, or improve its functionality with exposure to data such that improved performance of a particular task, or more desirable responses to particular stimuli, may be “learned” or developed by the mechanism.

The quadrotors of the present disclosure may be any unmanned arial vehicle (UAV) which is configured to use spinning rotors to generate thrust. The control scheme of the present disclosure may be applied to any plurality of UAVs, including but not limited to helicoptors, dicopters, tricopters quadcopters, hexacopters, and octocopters.

The cyber-attack of the present disclosure may be any malicious digital signal which are configured to interrupt the operation of at least one UAV of the present disclosure. The cyber-attack may be, amongst other attacks, a distributed denial of service attack, a sensor deception attack, or an actuator injection attack.

Numerous modifications and variations of the present disclosure are possible in light of the above teachings. It is therefore to be understood that within the scope of the appended claims, the invention may be practiced otherwise than as specifically described herein.

1. A method for controlling the flight of a plurality of quadcopters, comprising:
communicating a flight instruction from a user to a leader quadcopter;
calculating a leader formation maneuver and a follower formation maneuver with a leader-follower formation controller configured to use affine transformations and stress matrices to convert the flight instruction into a leader formation maneuver and a follower formation maneuver;
communicating the follower formation maneuver from the leader quadcopter to a follower quadcopter;
executing the leader formation maneuver on the leader quadcopter; and
executing the follower formation maneuver on the follower quadcopter.

2. The method of claim 1, wherein the leader-follower formation controller is further configured to utilize a barrier function to calculate the leader formation maneuver and the follower formation maneuver.

3. The method of claim 2, wherein the barrier function is a Lyapunov candidate function which trends to infinity at a predetermined constraint value.

4. The method of claim 2, wherein the leader-follower formation controller is further configured to use an actor-critic learning mechanism.

5. The method of claim 4, wherein the actor-critic learning mechanism is a machine learning algorithm.

6. The method of claim 1, wherein the leader-follower formation controller is further configured to use a distributed sliding mode control.

7. The method of claim 6, wherein the distributed sliding mode control is configured to use a control law to protect at least one of the plurality of quadcopters from a malicious cyber-attack.

8. The method of claim 7, wherein the malicious cyber-attack is a distributed denial of service attack, a sensor deception attack, or an actuator injection attack.

9. The method of claim 7, wherein the distributed sliding mode control is configured to use a Nussbaum gain function to mitigate the effects of input gain on the follower formation maneuver, the input gain being created by a malicious cyber-attack.

10. The method of claim 1, wherein the follower formation maneuver comprises:
a scaling maneuver;
a shearing maneuver;
a translation maneuver; and
a collinearity maneuver.

11. The method of claim 10, wherein the position of each of the plurality of quadcopters within the follower formation maneuver is defined by:
an x position;
a y position;
a z position;
a roll angle;
a yaw angle; and
a pitch angle.

12. The method of claim 1, wherein the leader-follower formation controller is configured to use a radial basis function neural network to smooth a flight instruction after the flight instruction has been communicated from a user to a leader quadcopter.

13. A method for controlling the flight of a plurality of quadcopters, comprising:
communicating a flight instruction from a user to a leader quadcopter;
calculating a leader formation maneuver and a follower formation maneuver with a leader-follower formation controller configured to use a distributed sliding mode control and an actor-critic learning mechanism to convert a flight instruction into a leader formation maneuver and a follower formation maneuver;
communicating the follower formation maneuver from the leader quadcopter to a follower quadcopter;
executing the leader formation maneuver on the leader quadcopter; and
executing the follower formation maneuver on the follower quadcopter.

14. The method of claim 13, wherein the sliding mode control is configured to convert the flight instruction into a follower formation maneuver with affine transformations and stress matrices.

15. The method of claim 13, wherein the actor-critic learning mechanism is a machine learning algorithm and the machine learning algorithm is further configured to use a radial basis function to smooth a flight instruction after the flight instruction has been communicated from a user to a leader quadcopter.

16. The method of claim 13, wherein the sliding mode control and the actor-critic learning mechanism are configured to use a control law to protect at least one of the plurality of quadcopters from a malicious cyber-attack.

17. The method of claim 16, wherein the distributed sliding mode control and the actor-critic learning mechanism are configured to use a Nussbaum gain function to mitigate the effects of input gain on a follower formation maneuver, the input gain being created by a malicious cyber-attack.

18. The method of claim 16, wherein the malicious cyber-attack is a distributed denial of service attack, a sensor deception attack, or an actuator injection attack.

19. A system for controlling a plurality of quadcopters, the system comprising:
a user input device configured to receive a flight instruction from a user and deliver the flight instruction to a leader quadcopter;
a leader quadcopter configured to:
receive a flight instruction from a user input device;
calculate a leader formation maneuver;
calculate a follower formation maneuver with a leader-follower formation controller configured to use affine transformations and stress matrices to calculate the follower formation maneuver;
communicate the follower formation maneuver to a follower quadcopter; and
execute the leader formation maneuver; and
a follower quadcopter configured to:
receive the follower formation maneuver; and
execute the follower formation maneuver.

20. The method of claim 19, wherein the leader-follower formation controller is further configured to use an actor-critic machine learning algorithm to calculate the follower formation maneuver.
